(19) United States
(12) Patent Application Publication
(10) Pub. No.: US 2014/0178550 A1
(43) Pub. Date: Jun. 26, 2014

(54) METHODS AND DEVICES FOR INGREDIENT PREPARATION

(71) Applicant: Fran Z. Slutsky, Providence, RI (US)

(72) Inventor: Fran Z. Slutsky, Providence, RI (US)

(73) Assignee: I+D+M CREATIVE, LLC, Providence, RI (US)

(21) Appl. No.: 14/233,311

(22) PCT Filed: Jul. 19, 2012
(86) PCT No.: PCT/US12/47421

§ 371 Date: Jan. 16, 2014

Related U.S. Application Data
(60) Provisional application No. 61/509,692, filed on Jul. 20, 2011.
(60) Provisional application No. 61/530,110, filed on Sep. 1, 2011.

(51) Int. Cl. A23P 1/10

(52) U.S. Cl. CPC A23P 1/105
USPC 426/512; 249/204

(57) ABSTRACT

An ingredient preparation device (100, 200) is disclosed and may include one or more of an openable ring (110), a non-openable ring (210), a removable panel (10), and an optional tamper (190). One or more optional shaped inserts (180) may be used within the ring. An ingredient preparation device (100, 200) of the invention may be utilized alone or with one or more additional ingredient preparation devices of the invention. Methods of preparing one or more ingredients to make products such as foods or non-food items using such a device are disclosed herein.

### RELATED APPLICATIONS

This application claims the benefit under 35 U.S.C. §119(e) of U.S. Ser. No. 61/509,692 filed Jul. 20, 2011 and U.S. Ser. No. 61/530,110 filed Sep. 1, 2011, the entire contents of each of which is incorporated herein by reference.

### FIELD OF THE INVENTION

This invention relates to molds, and more particularly, to molds, tools, and cooking and baking pans used in preparation, arrangement, and/or presentation of edible and non-edible ingredients.

### BACKGROUND

Arrangement of food to enhance its aesthetic appeal and taste is a consideration in creating a successful dish. Attentive food plating and presentation are significant to restaurant chefs, home cooks, and many others. Food presentation adds to the visual allure of the food and can enhance the savory nature of a given dish by providing contrast and/or balance of the arranged elements. Various tools for food preparation are available, including non-openable rings used for layering foods for presentation, and various molds and baking pans, such as spring-form pans, that can be used to cook and shape food and can be loosened or flipped over to allow removal of the prepared food. Molds and other preparation tools are also used for arranging non-edible ingredients such as molding clay, children's dough, and additional materials.

### SUMMARY OF THE INVENTION

According to one aspect of the invention, an ingredient preparation device is provided. The device includes a ring that when closed includes a continuous vertical wall having a top edge and a bottom edge, a major interior surface, and an exterior surface, the wall including a slot opening that transverses a portion of the wall; the device further including a removable panel including a first panel portion that is insertable into the ring through the slot opening. In some embodiments, the ring also includes a groove traversing at least a portion of the wall's interior circumference, and whereby an edge of the removable panel is positioned in the groove when the removable panel is maximally inserted into the ring. In certain embodiments, the groove defines the slot opening that transverses a portion of the wall. In some embodiments, the slot opening comprises at least ⅓ of the length of the groove. In some embodiments, the ring is an openable ring. In some embodiments, the width of the panel at its midpoint is greater than the width of the inner diameter of the ring at its midpoint. In certain embodiments, the width of the slot opening is greater than the inner diameter of the ring at its midpoint. In some embodiments, the removable panel includes a handle portion that extends outside the ring from the slot opening when the removable panel is maximally inserted into the ring. In certain embodiments, the width of the panel at its midpoint is greater than the width of the major interior surface at its midpoint. In certain embodiments, the removable panel includes one or more perforations. In some embodiments, the width of the panel is equal to or less than the inner diameter of the ring when measured from groove surface to opposing groove surface. In some embodiments, the groove is positioned in closer proximity to one wall edge than to the other wall edge. In some embodiments, the groove is aligned with at least one wall edge. In some embodiments, the width of the slot opening is greater than the inner diameter of a major interior surface. In certain embodiments, the groove is aligned with both wall edges. In some embodiments, the groove traverses the entirety of the interior surface. In some embodiments, the length of the slot opening is less than the length of the groove. In some embodiments, the groove is parallel to the bottom edge. In certain embodiments, at least a portion of the ring includes and/or is made of silicone or rubber. In some embodiments, the portion of the ring includes the groove and the slot opening. In some embodiments, the panel portion is inserted in a plane parallel to the bottom edge. In certain embodiments, the circumference at the top edge is greater than or less than the circumference at the bottom edge. In some embodiments, the maximally inserted panel has a sealed interface with the ring. In some embodiments, the maximally inserted panel has a sealed interface with the silicon of the groove. In some embodiments, the sealed interface is a substantially liquid-tight interface. In certain embodiments, the sealed interface reduces the amount of, or prevents a liquid contained in the ring from passing between the groove and the removable panel. In some embodiments, the maximally inserted panel reduces the amount of a liquid contained in the ring from passing between the groove and the panel. In some embodiments, the ring includes one or more hinges. In some embodiments, the ring includes two, three, four, five, six, or more hinges. In certain embodiments, the ring includes a closure element. In some embodiments, the shape of the ring is not circular. In some embodiments, the shape of the ring is a square, heart, polygon, triangle, oval, star, tree, animal, building, car, flower, or plant. In certain embodiments, the shape of the ring is circular. In some embodiments, the ingredient preparation device also includes one or more shaped inserts that are configured to be fitted within the ring. In some embodiments, the ingredient preparation device also includes two, three, four, five, six, or more shaped inserts that can be fitted within the ring. In some embodiments, the ingredient preparation device also includes a temperature-regulating element. In certain embodiments, the device additionally includes a tamper that includes a body dimensioned to fit within the ring and a handle. In some embodiments, an edge of the body of the tamper includes a cutting edge. In some embodiments, the device is made of a non-toxic, food-safe material. In some embodiments, the device includes plastic, nylon, ceramic, metal, wood, silicone, nitrile, Teflon, and/or glass. In certain embodiments, the device is temperature resistant up to and including a temperature of at least 100° F., 150° F., 200° F., 250° F., 300° F., 350° F., 400° F., 450° F., or 500° F., including all temperatures in between these temperatures. In some embodiments, the device is temperature resistant down to and including a temperature of 60° F., 50° F., 40° F., 30° F., 20° F., 10° F., 5° F., 0° F., −5° F., −10° F., −25° F., −35° F., −45° F., or −50° F., including all temperatures in between these temperatures. In some embodiments, the device includes a non-stick surface. In some embodiments, the removable panel includes a non-stick surface. In some embodiments, a wall edge of the ring is configured to connect with a wall edge of a ring of a second ingredient preparation device. In certain embodiments, the device includes graduation marks. In some embodiments, the ring includes two or more hinges. In some embodiments, the ring includes two or more grooves each defining a slot opening. In certain embodiments, the ingredient includes one or more foods and/or one or more non-food elements. In some embodiments of the invention a device of the invention also includes a cover or lid that is configured to fit onto a top and/or bottom edge of the ring.

According to another aspect of the invention, methods of ingredient preparation are provided. The methods include placing a first ingredient into a ring of a device of any one or more embodiments of the aforementioned ingredient preparation devices. In some embodiments, the removable panel is maximally inserted into the ring of the first device prior to placement of the first ingredient into the first device. In some embodiments, the method also includes tamping the ingredient in ring of the device. In some embodiments, the method also includes placing an additional ingredient on top of a previously placed ingredient, and optionally repeating the placement of one or more additional ingredients one or more times. In certain embodiments, following one or more ingredient placements, a placed ingredient is tamped. In some embodiments, the method also includes placing and/or interconnecting a ring of a second device on top of the ring of the first device and placing one or more ingredients into the ring of the second device. In some embodiments, the removable panel is maximally inserted into the ring of the second device prior to placement of one or more ingredients into the ring of the second device. In some embodiments, one or more shaped inserts are fitted into a ring the first and/or second device. In certain embodiments, two, three, four, five, six, or more shaped inserts are fitted within the ring of the first and/or second device. In some embodiments, the ingredient includes one or more foods and/or one or more non-food items. In some embodiments, one or more ingredients are heated in the ingredient preparation device. In certain embodiments, an ingredient is cooked in the ingredient preparation device. In some embodiments, the ingredient includes a batter and the batter is cooked in the ring of the device. In some embodiments, the method also includes placing a ring of a second device containing an ingredient layer on top of a ring of a first device containing at least a first ingredient layer and a second ingredient layer, removing the removable panel of the ring of the second device and positioning the ingredient layer from the ring of the second device onto the second ingredient layer of the ring of the first device. In certain embodiments, the first ingredient layer in the ring of the first device and the ingredient layer in the ring of the second device include cooked batter. In some embodiments, the second ingredient layer in the ring of the first device includes a filling and/or frosting. In some embodiments, the ingredient is cooled in the ingredient preparation device. In certain embodiments, the ingredient is washed in the ingredient preparation device. In some embodiments, the ingredient is strained in the ingredient preparation device. In some configurations of the device and with certain ingredients the device can be placed and/or utilized in a horizontal orientation and in certain embodiments, a device of the invention can be placed and/or used in a vertical orientation. In some configurations of the device two or more rings of the invention may be used together to make a horizontal stack of ingredients or may be used together to make a vertical stack of ingredients.

The present invention is not intended to be limited to a system or method that must satisfy one or more of any stated objects or features of the invention. It is also important to note that the present invention is not limited to the exemplary or primary embodiments described herein. Modifications and substitutions by one of ordinary skill in the art are considered to be within the scope of the present invention.

### BRIEF DESCRIPTION OF THE DRAWINGS

FIG. 1 illustrates a side perspective view of an assembled ingredient preparation device with an optional tamper, configured in accordance with an embodiment of the present invention. In this illustrated embodiment, the ring is an openable ring.

FIG. 2 illustrates a side perspective view of an assembled ingredient preparation device with an optional tamper, configured in accordance with an embodiment of the present invention. In this illustrated embodiment, the ring is a non-openable ring.

FIG. 3 illustrates a top plan view of an ingredient preparation device, configured in accordance with an embodiment of the present invention.

FIG. 4 illustrates a side plan view of an assembled ingredient preparation device, configured in accordance with an embodiment of the present invention.

FIG. 5 illustrates an exploded side-perspective view of an ingredient preparation device, configured in accordance with an embodiment of the present invention.

FIG. 6 illustrates a side perspective view of two ingredient preparation devices, configured in accordance with an embodiment of the present invention.

FIG. 7 illustrates a side plan view of two stacked ingredient preparation devices, configured in accordance with an embodiment of the present invention.

FIG. 8 illustrates a side perspective view of an ingredient preparation device assembled with an optional shaped insert, configured in accordance with an embodiment of the present invention.

FIG. 9 illustrates an exploded side-perspective view of an ingredient preparation device with an optional shaped insert, configured in accordance with an embodiment of the present invention.

FIG. 10 is a schematic diagram illustrating a method of preparing ingredients, configured in accordance with an embodiment of the present invention. FIG. 10A depicts insertion of an optional removable panel into a slot opening of an openable ring. FIG. 10B depicts optionally cutting one or more ingredients via an optional cutting edge of a tamper and layering ingredients into an openable ring having a removable panel in place or optionally without such panel. FIG. 10C depicts one or more layers of ingredients being tamped or pressed down tightly within an openable ring by use of a tamper. FIG. 10D depicts a second openable ring with an optional removable panel being stacked on top of the first openable ring. FIG. 10E depicts one or more removable panels being removed and one or more openable rings being opened while optionally holding the ingredients in place with a tamper to ensure stability. Note that in the drawing, ring 110 is positioned with its bottom edge circumference on a surface and that the plane delineated by the bottom edge circumference of the ring (with the ring closed) would be considered essentially horizontal in relation to the vertical walls of the ring

FIG. 11 illustrates an exploded perspective view of an ingredient preparation device with an optional insert, configured in accordance with an embodiment of the present invention.

FIG. 12 illustrates a flow diagram illustrating a method of preparing ingredients, configured in accordance with an embodiment of the present invention, optionally using two ingredient preparation devices.

FIG. 13 illustrates an exploded perspective view of an ingredient preparation device with an optional insert, configured in accordance with an embodiment of the present invention. In this illustrated embodiment, the ring is an openable ring.

FIG. 14 illustrates an exploded perspective view of an ingredient preparation device with an optional insert, configured in accordance with an embodiment of the present invention. In this illustrated embodiment, the ring is a non-openable ring. Note that ring 210 is shown with bottom edge 228 facing up to permit a clear view of the slot opening 240. In some embodiments of the invention, ring 210 may be positioned such that bottom edge 228 is facing down, for example, so that the bottom edge may be in contact with a plate, countertop, or other preparation surface on which the ring is positioned.

FIG. 15 shows schematic diagrams of examples of ring configurations. FIG. 15A shows a ring with a single opening and no hinge. FIG. 15B shows a ring with two openings positioned approximately equidistant from each other and no hinge. FIG. 15C shows a ring with two openings not positioned equidistant from each other, and no hinge. FIG. 15D shows a ring with three openings and no hinge. FIG. 15E shows a ring with a single hinge and a single opening positioned approximately equidistant from each other around the ring. FIG. 15F shows a ring with a single hinge and a single opening that are not positioned equidistant from each other around the ring. FIG. 15G shows a ring with a single opening and three hinges. As shown, open circle represents a ring, filled box represents a ring opening, and filled circle represents a hinge position.

FIG. 16 illustrates a side perspective view of an assembled ingredient preparation device, configured in accordance with an embodiment of the present invention. In this illustrated embodiment, the ring is an openable ring and has three circular sections, the sides of each of which swing apart approximately in half when the ring is opened

FIG. 17 illustrates a side perspective view of an assembled ingredient preparation device, configured in accordance with an embodiment of the present invention. In this illustrated embodiment, the ring is approximately square in shape and is a non-openable ring.

FIG. 18 illustrates a side perspective view of an assembled ingredient preparation device, configured in accordance with an embodiment of the present invention. In this illustrated embodiment, the ring approximately square and is an openable ring.

FIG. 19 illustrates a side perspective view of an assembled ingredient preparation device of the invention, configured in accordance with an embodiment of the present invention. In this illustrated embodiment, the ring is an openable ring.

These and other features of the present embodiments will be understood better by reading the following detailed description, taken together with the figures herein described. The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION

An ingredient preparation device as described herein may be used to arrange edible and/or non-edible ingredients into a layered stack that includes one or more layers of ingredients. A device of the invention includes a ring into which one or more layers of ingredients can be placed. After ingredient placement, the ring may be removed from the ingredient layers, leaving a layered stack or a single layer of the ingredients. In some embodiments of the invention, a ring of a device is an openable ring into which, when in its closed position, one or more layers of ingredients can be placed. After ingredient placement, the openable ring may be opened and removed from the ingredient layers, leaving a layered stack or a single layer of the ingredients. In some embodiments, a ring of a device is a non-openable ring. After ingredient placement in a non-openable ring, a layered stack of ingredients or a single layer of an ingredient can be removed through the top or bottom of the ring. As used herein, the term “closed ring” can refer to a ring that is an openable ring in its closed configuration or can refer to a ring that is non-openable ring.

It will be understood that the term “vertical” used in reference to the wall of a ring of a device of the invention means essentially vertical relative to a plane that is delineated by an edge circumference of the closed ring of a device of the invention. Thus, in some embodiments of the invention, an essentially vertical wall of a ring of the invention is within 5 degrees of 90 degrees of the plane delineated by an edge circumference of the closed ring of a device of the invention. In other embodiments, the vertical wall may be within 1, 2, 3, or 4 degrees of 90 degrees of the plane delineated by an edge circumference of the closed ring of a device of the invention. In some embodiments of methods of the invention, a ring of the invention may be positioned such that its vertical wall is essentially vertical relative to a surface on which the edge circumference of a ring is positioned for use, although as described elsewhere herein methods of using a device of the invention may include positioning a ring of the invention in a horizontal orientation, a vertical orientation, or any orientation in between horizontal and vertical, with respect to a work surface such as a table, plate, etc.

An openable or non-openable ring device of the invention may also include a slot opening through which a panel can be inserted. In some embodiments of the invention, a slot opening of an openable or non-openable ring of the invention may comprise at least ⅓ of the length of the groove. It will be understood that in some embodiments of the invention, the width of the slot opening is greater than the inner diameter of a major interior surface of the ring. In some embodiments of the invention, the width of the removable panel at its midpoint is greater than the diameter of the ring measured across the midpoint of the major interior surface. In certain embodiments of the invention, the width of the panel is equal to or less than the inner diameter of the ring when measured from the groove surface to groove surface. The groove in some embodiments of a ring of the invention comprises a recession extending outwardly from the major interior surface of the ring. Thus, it will be understood that the diameter of the ring measured from a groove surface to groove surface across a ring of the invention will be greater than the diameter of the major interior surface of the ring at that position in the ring. Thus, the diameter of a removable panel may, in some embodiments of the invention be wider than the major inner wall diameter and narrower than the largest outer wall portion diameter. In certain embodiments of the invention, the diameter of a removable panel may be wider than the major inner wall diameter and equal to or narrower than the diameter of the groove surface to groove surface across a ring of the invention as measured with no panel inserted. In some embodiments of the invention the diameter of a removable panel may be wider than the diameter of the groove surface to groove surface across a ring of the invention as measured with no panel inserted, and the groove surface or inserted edge of the panel may be compressed by the insertion of the removable panel into the groove. In some embodiments of the invention, the outer diameter of a ring of the invention is measured at the groove portion of the ring. It will be understood that a non-uniform shaped ring may have different inner and outer diameters depending on the position of the measured diameter on the ring and that a suitable shape and size of a removable panel can be determined based on the shape and size of the ring of the invention. In some embodiments, the shape of a removable panel may be similar or identical to the shape of the ring, but may be smaller so as to fit within the internal dimension of the ring and/or within a groove in the ring. Those skilled in the art will be able to use known methods to determine the diameter(s) of a ring and select an appropriate sized and configured removable panel for use with such a ring.

In some embodiments, such a panel can be positioned as a base for the one or more ingredient layers that are placed into the ring, and in some embodiments, such a panel can be positioned as a divider between layers of ingredients. For example if a panel is inserted into a ring of the invention and one or more ingredient layers are placed consecutively on top of the panel, the panel may be the base for that ingredient layer or the layered stack. Having such a removable base permits the layer or layered stack to be prepared on any surface and then moved to a desired surface such as a plate or a serving dish, etc. at any point during or after the layer or layers are prepared. Using the removable panel as a base in a ring of the invention can permit positioning of a ring containing a layer or layered stack onto a desired surface such as a plate or serving dish, sliding the base panel out of the ring through the slot opening, and removing the ring, which allows the layer or layered stack of ingredients to be readily positioned on the desired surface. In embodiments of the invention that include an openable ring, the ring may be opened prior to, or after removal of the ring from the ingredients.

Inclusion of a slot opening in an openable or non-openable ring of a device of the invention also permits, in some embodiments, use of a removable panel as described herein, as a removable divider that may be inserted into a ring of the invention over one layer of ingredients and another layer of ingredients may be placed on top of the panel. Such a dividing panel may help stabilize the ingredient stack, keep different ingredient layers well defined, etc. and the dividing panel can be slid out of the ring through the slot opening and removed when assembly of the ingredient stack when desired, e.g. when the stack has been completed, the stack is ready for serving, etc. Thus, the design and features of an ingredient preparation device of the invention permit rapid, precise, and accurate arrangement of stacked layers of food or other ingredients or mixtures of ingredients. In addition, features of a ring of a device of the invention such as openability and/or use of a removable panel permit easy and efficient removal of one or more ingredients from the ring. For example, by opening a ring of the invention and/or by removing a removable panel of a ring of the invention ingredients can be readily removed from the ring without the need for flipping or inverting the ring and without the use of spatulas or other devices to pry and/or lift out the ingredient(s) and/or the prepared food or non-food product. In some embodiments of the invention a device of the invention also includes a cover or lid that is configured to fit onto a top and/or bottom edge of an openable or non-openable ring of the invention. A lid or cover may be configured such that when fitted onto a ring it provides a seal for the ring. In some embodiments the seal may be an air-tight seal and/or a liquid-tight seal for the ring. In certain embodiments, a seal between a lid or cover and a ring of the invention may be an ingredient seal that prevents or reduces that likelihood of spillage or loss of one or more ingredients placed within the ring. It will be understood that a lid or cover can be positioned on the top or the bottom of a ring of the invention, and that more than one lid or cover can be used such that there is a lid or cover positioned on the top and a lid or cover positioned on the bottom of the ring. In some embodiments of the invention a lid or cover may be positioned on the top or on the bottom of a ring of the invention during a heating, cooling, chilling, freezing process or during any step of an ingredient preparation method of the invention.

It will be understood that the design and features of a device of the invention also permit preparation and presentation of a single layer of an ingredient. As a non-limiting example, a single layer of a cake batter can be placed into a device of the invention that has a removable panel in place as a base, and after cooking, the base can be removed through the slot opening and the cooked cake removed from the ring allowing for placement and/or presentation of the prepared cake. In embodiments of the invention that include an openable ring, steps for removing the cake may comprise opening the ring. In some methods of the invention, two or more food preparation devices can be used in conjunction with each other to prepare a food with multiple layers of cooked and/or uncooked ingredients. For example, a ring of a second device of the invention that contains at least one ingredient layer can be placed on top of a ring of a first device of the invention. The ring of the first device of the invention may contain at least a first ingredient layer and optionally, may contain a second ingredient layer. The removable base panel in the ring of the second device can be removed from the slot opening after the ring has been placed on top of the ring of the first device, allowing the ingredient layer contained in the ring of the second device to be positioned onto the uppermost ingredient layer in the ring of the first device.

As a non-limiting example, if a ring of a first device contains an ingredient layer such as a dough or batter (e.g. a cake batter, bread dough, etc.), the dough or batter can be cooked in the ring of the first device, and then another ingredient (e.g., a desired filling, etc.) can be layered on top of the cooked dough or batter layer. A ring of a second device that also includes cooked bread dough or cake batter can be readily and accurately placed on top of the ring of the first device and the cooked layer of the ring of the second device positioned onto the uppermost layer of the ring of the first device, and the removable panel removed from the ring of the second device. Optionally, a tamper may be used to tamp or push the layer from the ring of the second device onto the uppermost layer of the ring of the first device, though in some embodiments, layers may be positioned and placed without the use of a tamper. In some embodiments, two or more additional ingredient layers can be included in an ingredient stack prepared using one or more devices of the invention. Use of two or more devices of the invention can permit quick and accurate alignment of multilayered food preparations. Ingredients used in devices of the invention may include, but are not limited to, any substances of suitable size to be arranged using the device. For example, whole, diced, cubed, shredded or other forms of fruit, vegetables, meats; frosting, ice cream, sorbet, sherbet, fruit, jam, curd, chocolate, nuts, butter, sauce, purees, etc. can be used as ingredients in a device of the invention. As used herein, the term “ingredient” can be a single food or item or can be a single mixture of more than one food or item. For example, a layer of chopped tomatoes is considered an ingredient that can be positioned as a layer in a device of the invention. A mixture of chopped tomatoes and onions can also be considered an ingredient that can be positioned as a layer in a device of the invention. Similarly, a cake batter (which is a combination of elements such as sugar, flour, butter, etc.) is considered to be an ingredient that can be positioned as a layer in a device of the invention.

In some embodiments, an ingredient may be a non-edible item including, but not limited to, modeling compound, sand, gelable substances, resins, clay, stones, glass pieces, plaster, glue, plant matter, dirt, or any other suitable materials as would occur to one of ordinary skill in the art.

Ingredients that are solids, liquid, gels, and of other consistencies may be used in a device of the invention. Examples of liquids include, but are not limited to, thin liquids such as milk, water, etc. and thick liquids, such as honey, cake batter, suspensions, etc. As a non-limiting example, unset pudding may be placed as a layer into a device of the invention and allowed to set. Numerous alternative and additional ingredients may be arranged using a device of the invention according to a user's preference. Both solid and liquid ingredients may be utilized in a single device. For example, a mixture of chopped tomatoes and onions can be placed as a layer in a ring of a device of the invention and a mixture comprising raw egg can be poured into that layer. The mixture of ingredients can then be heated and cooked in the ring. Thus in some embodiments of the invention, an ingredient preparation device of the invention can be used to make layered food preparations, which may include two or more layers of foods having different colors, textures, tastes, consistencies, etc. As described herein, one more ingredients may be layered into a multi-layered ingredient stack using devices and/or methods of the invention. Thus, a device of the invention can be used to enhance food presentation, organization, and plating.

In some embodiments, a device of the invention can be used for baking or cooking one or more ingredient layers. For example, a batter, pudding, gel, a layered stack of vegetables, meats, eggs, etc. can be placed into a device of the invention and cooked or baked as desired using a heat-providing apparatus. Non-limiting examples of a heat-providing apparatus include, but are not limited to a convection oven, a conventional oven, microwave, a burner, a grill, a fire, a warm or hot water bath, a broiler, a toaster, etc. In some embodiments, a device of the invention may comprise a temperature-regulating element that is part of the device and that can be used to heat and/or cook ingredients in the device. A device of the invention can be used with any suitable combination of ingredients to prepare and heat and/or cook a single layer of an ingredient or ingredient mixture or to prepare and heat and/or cook multiple layers of ingredients, (e.g., 2, 3, 4, 5, or more layers of ingredients). For example, a batter or dough can be one layer that is cooked and frosting can be added as another layer on top of the cooked layer after cooking. Optionally one or more additional cooked or uncooked ingredient layers can be added on top of the previously positioned layers.

In some aspects of the invention a device of the invention can be used for cooling and/or setting one or more layers. For example, a pudding, gel, a layered stack of vegetables, meats, eggs, etc. can be placed into a device of the invention and chilled to, and/or held at a desired temperature and/or consistency using a chilling apparatus. Non-limiting examples of a chilling apparatus include, but are not limited to a refrigerator, cooler, freezer, ice-water bath, etc. In some embodiments, a device of the invention may comprise a temperature-regulating element that is part of the device and that can be used to lower the temperature of ingredients in the device. A device of the invention can be used with any suitable combination of ingredients to prepare and cool a single layer of an ingredient or ingredient mixture or to prepare and chill multiple layers of ingredients, (e.g., 2, 3, 4, 5, or more layers of ingredients). For example, a puree or pudding can be one layer that is chilled and filling layer can be added on top of the chilled layer. Optionally one or more additional chilled or un-chilled ingredient layers can be added on top of the previously positioned layers.

It will be understood that in some embodiments of the invention, layers of ingredients can be added and cooked and/or chilled at different temperatures using the same device of the invention. For example, an uncooked batter can be added to a ring of a device of the invention, the batter cooked at a suitable cooking temperature in the ring, the ring cooled, and another layer (e.g., ice cream, etc.) added to the ring, which is at a suitable temperature that is colder than the cooking temperature.

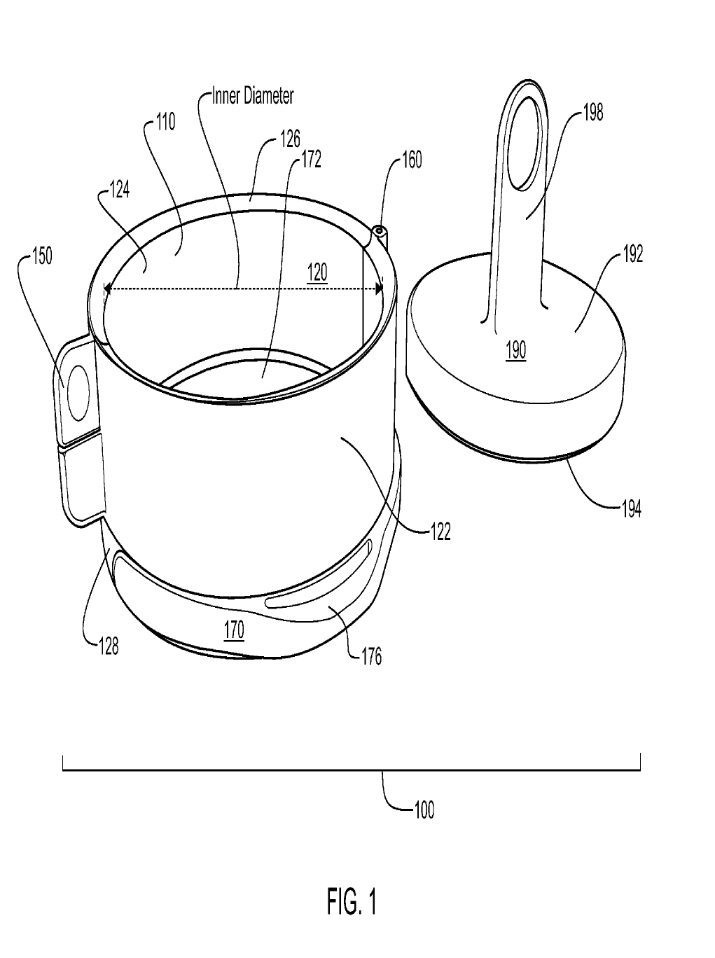

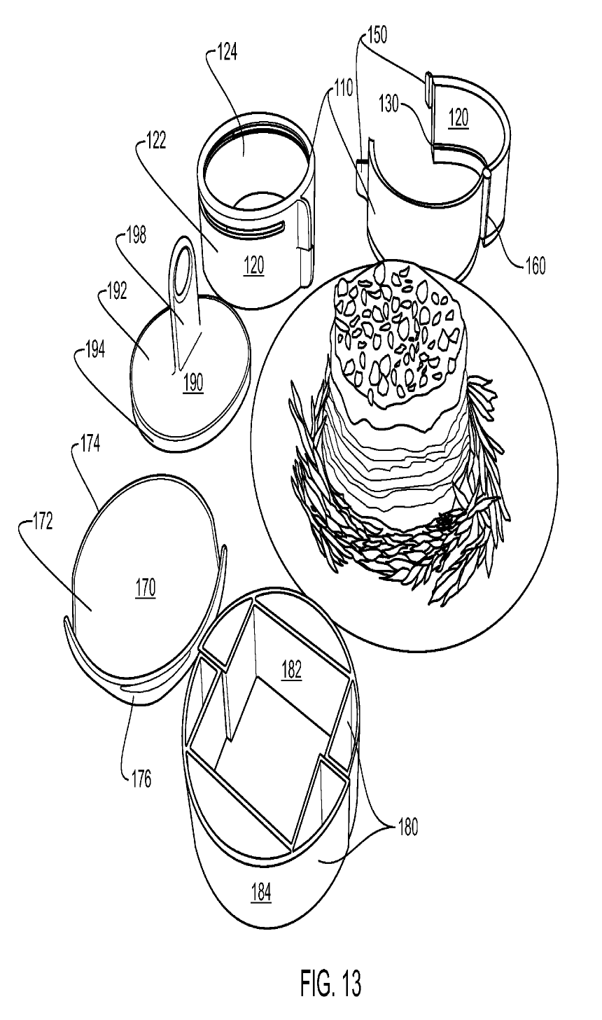

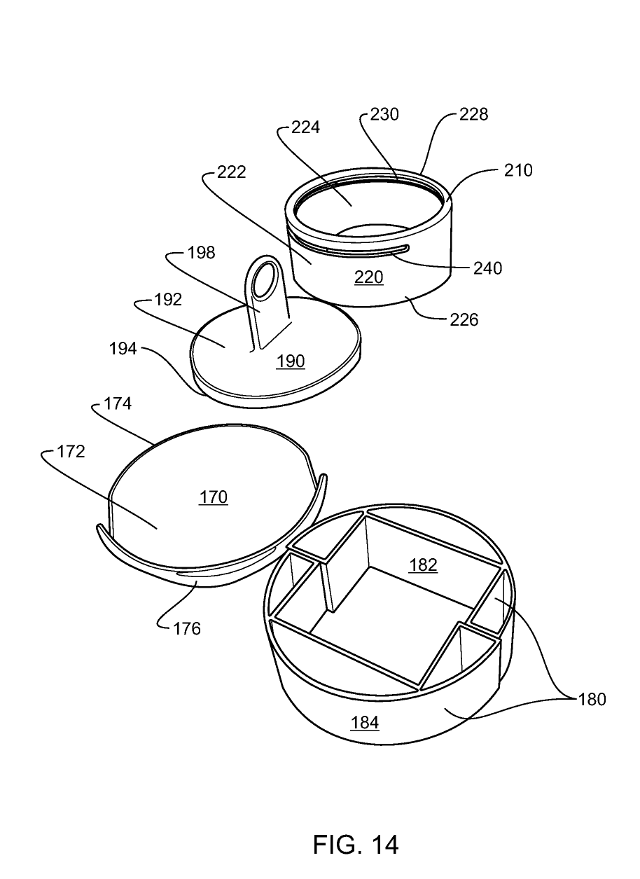

FIG. 1 illustrates a side perspective view of an assembled ingredient preparation device with an optional tamper, configured in accordance with an embodiment of the present invention. As can be seen, ingredient preparation device 100 may comprise an openable ring 110, an optional removable panel 170, and a tamper 190. The inner diameter of an openable ring is illustrated in FIG. 1, which shows the dimension of the inner diameter as the distance between a first position and a second position on the interior major wall surfaces, wherein the first and second positions are opposite from each other on the ring. It will be understood that an inner diameter of a non-openable ring may be defined in the same manner. As used herein, the term “major” wall surface means the wall surface that is not within a groove. Embodiments showing a groove and a major wall surface are illustrated in FIGS. 13 and 14. FIG. 13 illustrates groove 130 and major interior surface 124 of an embodiment of an openable ring and FIG. 14 illustrates groove 230 and major interior surface 224 of an embodiment of a non-openable ring.

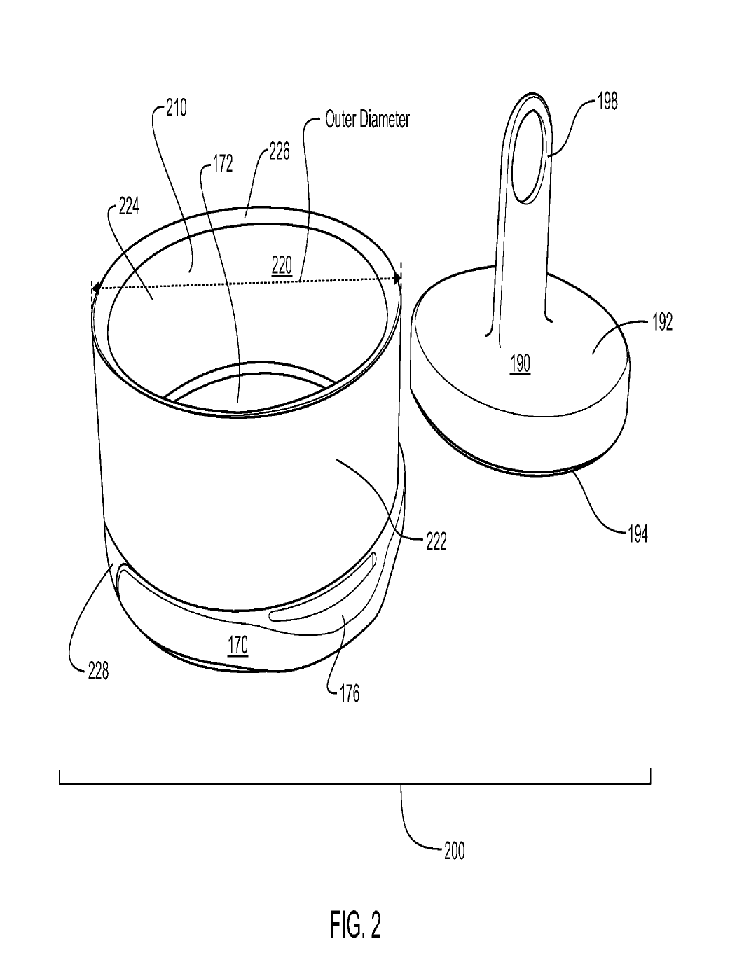

It will be also be understood that an outer diameter of an openable ring may be the dimension from a first position on the exterior surface of the wall of the ring, across the ring to a second position on the exterior surface of the wall of the ring, wherein the first and second positions are opposite each other on the ring. An example of dimension of an outer diameter of a non-openable ring is illustrated for in FIG. 2, and it will be understood that an outer diameter dimension for an openable ring may be determined in a similar manner. It will be understood that a non-uniform shaped ring may have different inner and outer diameters depending on the position of the measured diameter on the ring and on the thickness of the ring. Those skilled in the art will be able to assess the diameter of a ring of the invention using known methods.

Openable ring 110 may have a continuous vertical wall 120 (ring is in a closed configuration) with an exterior surface 122 and an interior surface 124 (also referred to herein as a major interior surface). Wall 120 may have, for example, a top edge 126 and a bottom edge 128. Ring 110 may have one or more vertical wall openings, at which sections of the ring may be separated from each other. A ring is in its closed configuration, is considered to have a continuous wall. When a ring is in its open position it does not have a continuous wall and one or more wall sections may separate from each other at the wall opening. If a ring has a single vertical wall opening, the vertical wall edges at either side of the vertical wall opening may separate from each other when the ring is in its open configuration, as compared to the wall being continuous when the ring is in its closed configuration. In an embodiment of a ring with a single vertical wall opening, the ring would remain in one piece when in its open configuration. A ring with a single vertical wall opening may have a closure element and may have zero, one, two, three, or more hinges. Ring 110 may be circular or non-circular in shape. A non-circular ring 110 may be of any shape, including, but not limited to, a square, a heart, a polygon, a triangle, an oval, a star, a tree, an animal, a building, a car, a flower, or a plant, etc. Ring 110 may be cylindrical, with top edge 126 and bottom edge 128 having the same or substantially the same circumference. In another embodiment, for example, ring 110 may be conical or semi-conical, with top edge 126 and bottom edge 128 having different circumferences.

Openable ring 110 may have at least one closure element 150 for securing ring 110 in a substantially closed position. Closure element 150 may include, but is not limited to, a tab and retainer system, a snap closure, a buckle, a clip, a screw, a pin and receiver closure, a magnetic closure, a strap that can be fitted around the ring to hold the ring in a closed position, or any other acceptable means of closing openable ring 110 as would occur to one of ordinary skill in the art, or any combination of the aforementioned. Closure element 150 may be integrated in part or in whole with openable ring 110, or may be separate and/or separable from openable ring 110. A closure element in a ring of a device of the invention can be positioned to hold together an opening in the wall of a ring. The wall of an openable ring of the invention is a continuous wall when the ring is in its closed position, but need not be a continuous wall when the ring is in its open position. For example, an open ring may include two or more wall pieces that separate from each other and may not remain in contact with each other when the ring is open but that are held in contact with each other forming a continuous wall when the ring is closed. Thus, pieces of the wall of a ring of the invention may be held together by one or more closure elements when an openable ring is in a closed configuration. Openable ring 110 may have, one, two, three, four, five, or more hinges 160 disposed on a periphery or as a hidden or embedded hinge thereof. In one particular embodiment, multiple hinges may be, for example, functionally connected in a proximate location or may be distally located so that ring 110 is articulated in several separate locations. As used herein, the term “hinge” refers to a suitable hinging mechanism including, but not limited to, a flexible material, strap, band, living hinge, pin hinge, butt hinge, flush hinge, etc. that permits articulation of the wall of a ring of the invention. A hinging mechanism may allow sections of the wall to rotate relative to each other about a fixed axis of rotation. The term “living hinge” refers to a thin flexible hinge, typically made from plastic or other flexible material that joins two parts (for example wall sections) together, allowing them to bend along the line of the hinge. In one embodiment, hinge 160 may be positioned substantially opposite closure element 150 and so may assist with ease of opening ring 110, though this is not essential for the proper functioning of device 100. In some embodiments, multiple hinges can be present in a ring at different positions around the perimeter of the ring. Presence of two or more hinges around the perimeter of a ring may provide flexibility in the shape of the ring, and so a ring with two or more hinges in the ring wall may be utilized in various shapes depending on the desired shape of the ingredient stack to be prepared. In some embodiments, an openable ring 110 has no hinges.

FIG. 2 illustrates a side perspective view of an assembled ingredient preparation device with a tamper, configured in accordance with an embodiment of the present invention. As can be seen, ingredient preparation device 200 may comprise a non-openable ring 210, an optional removable panel 170, and an optional tamper 190. FIG. 2, as described above herein, also illustrates the outer diameter in an embodiment of a ring of the invention. The figure illustrates that the outer diameter extends from a first position on the exterior wall surface across the ring to a second position on the exterior wall surface, which may be opposite the first position. In some embodiments of the invention, the “outer” diameter is the largest dimension that can be measured between two points on the outer surface that are in the same horizontal plane.

Non-openable ring 210 may have a continuous vertical wall 220 with an exterior surface 222 and an interior surface 224. Wall 220 may have, for example, a top edge 226 and a bottom edge 228. Ring 210 may be circular or non-circular in shape. A non-circular ring 210 may be of any shape, including, but not limited to, a square, a heart, a polygon, a triangle, an oval, a star, a tree, an animal, a building, a car, a flower, or a plant, etc. Ring 210 may be cylindrical, with top edge 226 and bottom edge 228 having the same or substantially the same circumference. In another embodiment, for example, ring 210 may be conical or semi-conical, with top edge 226 and bottom edge 228 having different circumferences. An embodiment of a non-openable ring 210 is also shown at the top of FIG. 14, which illustrates the groove 230 shown positioned around the interior of the wall 224, and the slot opening 240, which extends through the wall of the ring, and is which is shown extending around a portion of the ring's circumference.

In some embodiments, non-openable ring 210 may have one or more hinges disposed on a periphery or as a hidden or embedded hinge thereof. It will be understood that one or more hinges in a non-openable ring may be useful to permit the shape of a non-openable ring to be changed by bending or straightening the ring at one or more hinges. In one particular embodiment, multiple hinges may be, for example, functionally connected in a proximate location or may be distally located so that ring 210 is articulated in several separate locations. In some embodiments, multiple hinges can be present in a ring at different positions around the perimeter of the ring. Presence of two or more hinges around the perimeter of a ring may provide flexibility in the shape of the ring, and so a ring with two or more hinges in the ring wall may be utilized in various shapes depending on the desired shape of the ingredient stack to be prepared. In some embodiments, an openable ring 210 has no hinges.

Ingredient preparation device 100 or 200 may include an optional temperature-regulating element (not shown). Such element may include, but is not limited to, a thermal sleeve, a heating/cooling coil, an insulated wrapper, or any other means for raising and/or lowering the temperature of device 100 or 200, and/or its contents. Such temperature-regulating element may be useful in various ingredient assembly and/or preparation techniques including, but not limited to, congealing, melting, evaporating, reducing, crystallizing, drying, dissolving, freezing, chilling, or cooking, etc.

Ingredient preparation device 100 or 200 may include one or more optional removable panels 170. Removable panel 170 may include, for example, body portion 172 and optional handle portion 176. Removable panel 170 may be constructed of a rigid, semi-rigid, or flexible material, though no single construction is essential to the proper functioning of device 100 or 200. A panel 170 may be made of a single material or two or more materials, which can be arranged adjacent to each other and/or in layers on the panel 170. In one particular embodiment, optional handle portion 176 may be located completely outside of the exterior surface 122 of continuous vertical wall 120 of device 100, when panel 170 is maximally inserted into ring 110. In some embodiments, handle portion 176 may be partially inserted or embedded in exterior surface 122 of device 100, when the panel is maximally inserted into ring 110. In some embodiments, handle portion 176 may wrap around at least a portion of exterior surface 122 of device 100 when the panel 170 is maximally inserted into ring 110. In one particular embodiment, optional handle portion 176 may be located completely outside of the exterior surface 222 of continuous vertical wall 220 of device 200 when the panel 170 is maximally inserted into ring 210. In some embodiments, handle portion 176 may be partially inserted or embedded in exterior surface 222 of device 200 when the panel 170 is maximally inserted into ring 210. In some embodiments, handle portion 176 may wrap around at least a portion of exterior surface 222 of device 200 when the panel 170 is maximally inserted into ring 210. The dimensions of a removable panel may be a dimension configured to permit the panel to be inserted into a slot opening of a ring of the invention and the inserted edge fitted into a groove in a ring of the invention.

Ingredient preparation device 100 or 200 may include an optional tamper 190. Tamper 190 may include a body portion 192 and a handle portion 198. Body portion 192 may have an edge portion 194 thereon. In one particular embodiment, body portion 192 may have an optional cutting edge 196 thereon. Body portion 192 may be of any shape desired.

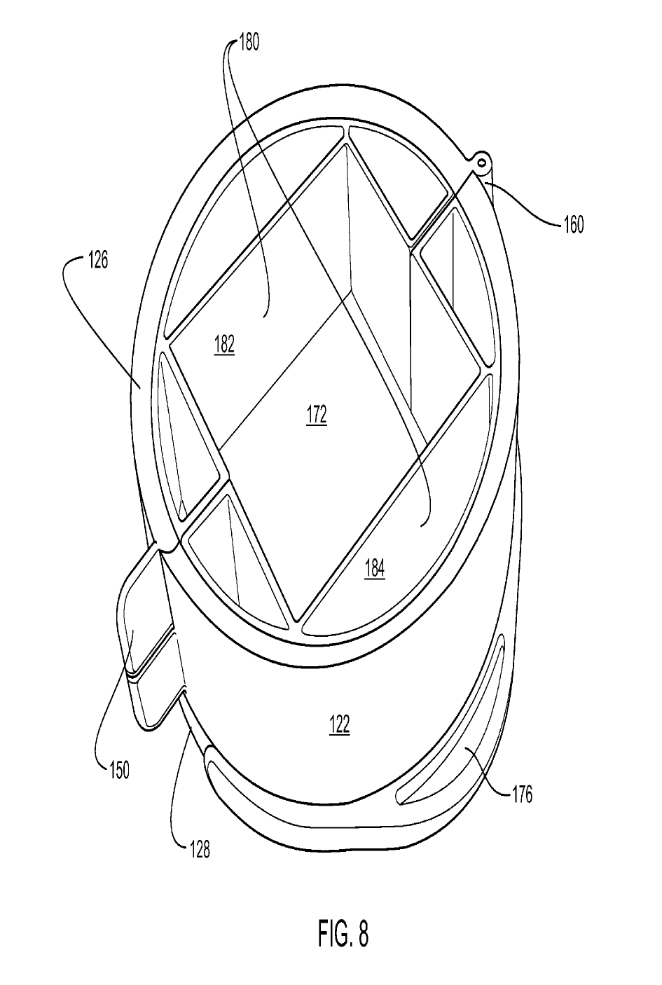

In one embodiment, body portion 192 may match the shape of non-openable ring 210, openable ring 110, and/or the shape of optional shaped insert 180, as discussed below with reference to FIG. 8, and may be sized to fit with non-openable ring 210, openable ring 110, and/or optional shaped insert 180. Handle portion 196 may be of any shape desired. In one particular embodiment, handle portion 196 may include a non-slip gripping surface and/or material disposed thereon. In another embodiment, handle portion 196 may include a recess, opening, or other means for receiving and/or engaging a hook, pin, or any other storage mechanism as would occur to one of ordinary skill in the art.

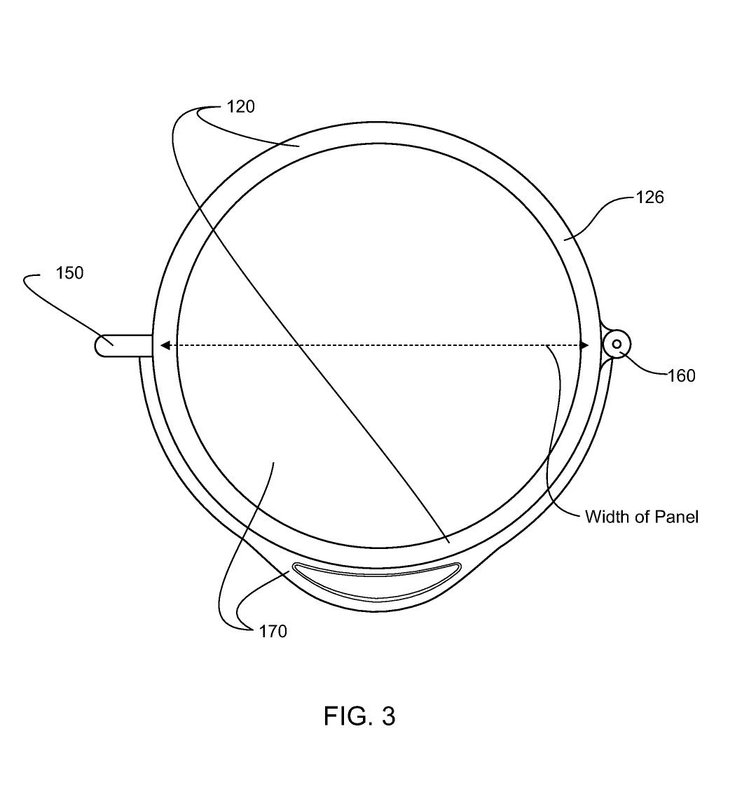

FIG. 3 illustrates a top plan view of an ingredient preparation device, configured in accordance with an embodiment of the present invention. As can be seen, in one embodiment, optional removable panel 170 may mate snugly with continuous vertical wall 120. FIG. 3 illustrates an embodiment of the invention in which the width (also referred to herein as the diameter) of removable panel 170 is greater than the wall's major interior surface diameter and less than the wall's exterior surface diameter of the ring. Removable panel 170 may be arranged so as to not interfere with the functioning of closure element 150 or hinge 160. In some embodiments of a device of the invention, either a device with a ring that includes a groove or with a ring that does not include a groove, elements and methods may be used to hold the removable panel against the interior wall of the ring. For example, a detent, key, clip, snap, or other means can be incorporated into a device and/or used in a device to hold the edge of the removable panel against the interior surface of the ring when the panel is maximally inserted through the slot opening of a ring that does not have groove that corresponds to that slot opening. Such a means may be incorporated into the ring and/or into the removable panel of a device. A means to hold the edge of the removable panel against the interior wall of the ring can provide stability for the panel in the ring and may also be used to form a substantially liquid-tight interface between the removable panel and the ring.

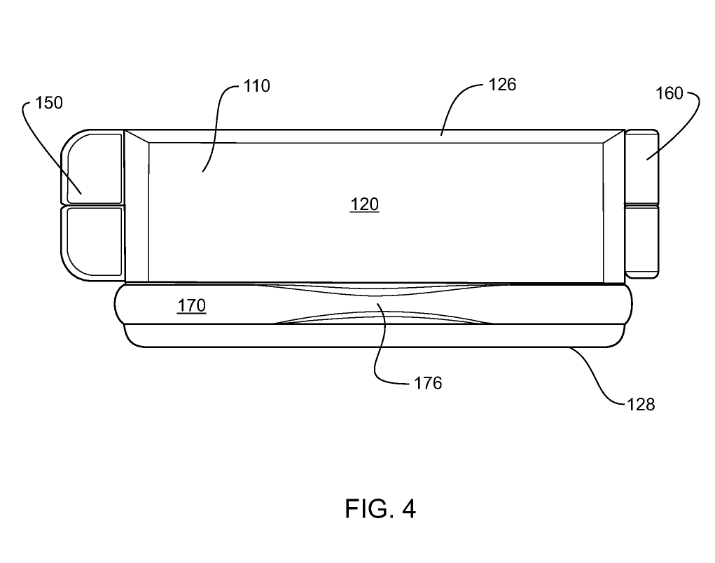

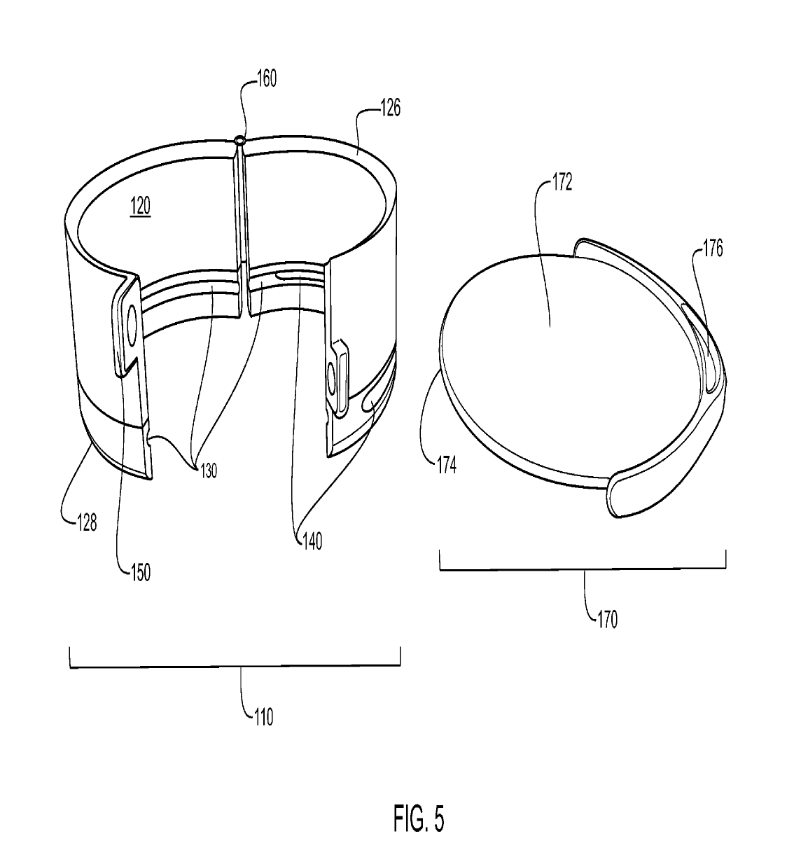

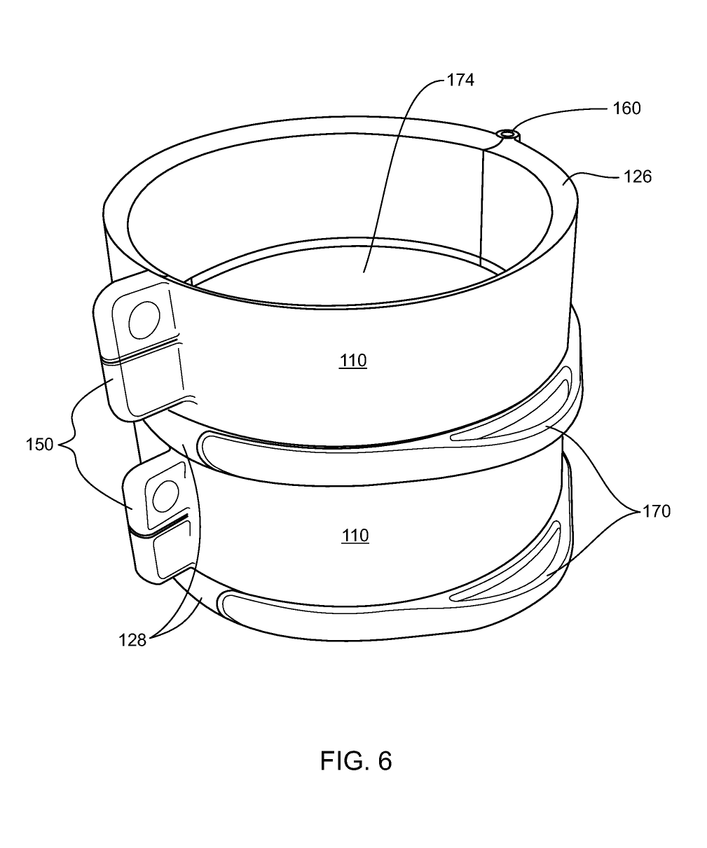

FIG. 4 illustrates a side plan view of an assembled ingredient preparation device, configured in accordance with an embodiment of the present invention. As can be seen, in one embodiment, optional removable panel 170 may be positioned or inserted through continuous vertical wall 120 via a slot opening 140, as discussed below with reference to FIG. 5, positioned at a location closer in proximity to bottom edge 128 than to top edge 126. In another embodiment, panel 170 may be insertable at one or more heights along wall 120; for example, a ring 110 may include two or more slot openings 140 at different positions along continuous vertical wall 120. Removable panel 170 may be arranged, for example, so as to not interfere with the functioning of closure element 150 and/or hinge 160. Similarly, non-openable ring 210 may include two or more slot openings at different positions along continuous vertical wall 220. In some embodiments, openable ring 110 has one, two, three, or more slot openings that are at different heights on the wall of the ring. In some embodiments, non-openable ring 210 has one, two, three, or more slot openings that are at different heights on the wall of the ring.

Openable ring 110 and non-openable ring 210 optionally may have graduation marks (not shown) thereon. Such graduation marks may be disposed on continuous vertical wall 120 or vertical wall 220 by any acceptable means as would occur to one of ordinary skill in the art, including, but not limited to, markings and/or etchings on exterior surface 122 and/or interior surface 124 of wall 120; or markings and/or etchings on exterior surface 222 and/or interior surface 224 of wall 220. Such graduation marks may indicate any type of measurements desirable, including, but not limited to, volume, quantity, height, percentage, or other general level. Such marks may be gradations in accordance with any one or more systems of indices and are not intended to be limited to any single unit of measure.

FIG. 5 illustrates an exploded side-perspective view of an ingredient preparation device, configured in accordance with an embodiment of the present invention. As can be seen, in one embodiment, openable ring 110 may have at least one groove 130 that traverses at least a portion of interior surface 124 of wall 120. In another embodiment, for example, groove 130 traverses the entirety of interior surface 124 of wall 120. Groove 130 may be positioned in closer proximity to one of either top edge 126 or bottom edge 128. In another instance, groove 130 may be positioned in alignment with at least one of top edge 126 or bottom edge 128 or with both edges 126 and 128. In one particular embodiment, groove 130 is arranged parallel to bottom edge 128. In another embodiment, groove 130 may traverse a path askew of one or more of edges 126 and/or 128, thereby sectioning the interior of openable ring 110 along one or more planes not parallel with edges 126 and/or 128. Such an embodiment may provide for sectioning and/or partitioning of different volumes and/or ingredients, etc., within openable ring 110. In another instance, multiple grooves 130 may traverse a portion or the entirety of interior surface 124 of wall 120. In such a case, multiple optional removable panels 170 may be utilized. Groove 130 may be arranged to provide an optional sealed interface. In one embodiment, such optional sealed interface may be, for example, substantially liquid-tight or otherwise capable of reducing the amount of or preventing a liquid from passing between groove 130 and optional removable panel 170, for example, when panel 170 is in its maximally inserted position. In some embodiments of the invention, a ring having a slot opening and a groove corresponding to that slot opening may also include a detent, key, clip, snap, bump, dimple, or other means incorporated into the ring and/or the panel, and/or a means used with the ring to hold the edge of the removable panel in contact with the groove when the panel is maximally inserted through the slot opening of the ring. Such a means may be incorporated into the ring and/or into the removable panel and may be used to produce a substantially liquid-tight interface between the interior wall of the ring and the inserted removable panel or in some embodiments, may be used to hold the panel in place without a liquid-tight interface between the ring and the inserted removable panel.

Similarly, non-openable ring 210 may have at least one groove 230 that traverses at least a portion of interior surface 224 of wall 220. An embodiment showing groove 230 is illustrated in FIG. 14. In some embodiments, groove 230 traverses the entirety of interior surface 224 of wall 220. Groove 230 may be positioned in closer proximity to one of either top edge 226 or bottom edge 228. In another instance, groove 230 may be positioned in alignment with at least one of top edge 226 or bottom edge 228 or with both edges 226 and 228. In one particular embodiment, groove 230 is arranged parallel to bottom edge 228. In another embodiment, groove 230 may traverse a path askew of one or more of edges 226 and/or 228, thereby sectioning the interior of non-openable ring 210 along one or more planes not parallel with edges 226 and/or 228. Such an embodiment may provide for sectioning and/or partitioning of different volumes and/or ingredients, etc., within non-openable ring 210. In another instance, multiple grooves 230 may traverse a portion or the entirety of interior surface 224 of wall 220. In such a case, multiple optional removable panels 170 may be utilized. Groove 230 may be arranged to provide an optional sealed interface. In one embodiment, such optional sealed interface may be, for example, substantially liquid-tight or otherwise capable of reducing the amount of or preventing a liquid from passing between groove 230 and optional removable panel 170, for example, when panel 170 is in its maximally inserted position.

As described herein, in some embodiments a ring of the invention comprises a slot opening through its wall and a corresponding groove on its interior wall. As used herein in reference to slot openings and grooves, the term “correspond” or “corresponding” means a groove on the interior wall of a ring into which an inserted edge of a removable panel inserted into a given slot opening is accepted when the removable panel is maximally inserted into that slot opening. Thus, when a removable panel is maximally inserted through a slot opening, the edge of the removable panel that enters the ring is accepted into a groove and that groove is referred to as “corresponding” to the slot opening. It will be understood that an edge that is “accepted” into a groove, may enter into the groove along a least a portion of the edge and/or a portion of the groove.

In certain aspects of the invention, it is contemplated that a ring of the invention may comprise a slot opening without a corresponding groove present on the internal wall. In some embodiments of the invention, a ring may have zero, one, or more grooves present on its interior wall, and zero, one, or more one slot openings that have no corresponding groove in the ring. Thus, in some embodiments, a removable panel may be maximally inserted into a ring through a slot opening that does not have a corresponding groove. A removable panel inserted into a slot opening without a corresponding groove may form a substantially liquid-tight, sealed interface with the internal wall surface of the ring. In such an embodiment, a sealed interface, including a substantially liquid-tight sealed interface, may be obtained by maximally inserting a removable panel into the ring, wherein the panel is positioned such that it is held or locked with sufficient pressure and/or contact between the internal edge of the maximally inserted removable panel and the interior surface of the ring to form a sealed interface that reduces the amount of, or does not permit a liquid in the ring from passing between the removable panel and the interior wall of the ring, when the panel is maximally inserted into the ring. In some embodiments of a device that does not include a groove, at least the edge portion of the removable panel and the wall of the ring contacted by the maximally inserted removable panel may be made of a material such as rubber, nitrile, silicone, plastic, etc. that can form a substantially liquid-tight, sealed interface between the panel and the wall when the panel is maximally inserted into the ring. In some embodiments of the invention, methods of ingredient preparation include use of a ring that has at least one slot opening that does not have a corresponding groove positioned on the interior wall surface.

As used herein the term “substantially liquid-tight” with respect to the interface components of a device of the invention, for example between a ring and a maximally inserted removable panel, between two vertical wall edges in a closed ring, between a hinge and a ring wall, etc. means up to 100%, 99%, 95%, 90%, 85%, 80%, (including every value there between) of liquid in a ring is prevented from passing between the components (e.g., prevented from passing between a ring wall and an inserted removable panel). Thus, in some embodiments a, maximally inserted removable panel limits the amount of a liquid that can pass between the wall and a maximally inserted removable panel and in some embodiments, the contact between two vertical wall edges in a closed ring is sufficient to result in a substantially liquid tight interface. It will be understood that not all devices or methods for using a device of the invention will require that an amount of a liquid passing between two components (e.g., the wall or groove and a maximally inserted panel, etc.) be significantly limited. Thus, in some embodiments of the invention, devices and methods in which up to 100%, 90% 80%, 70%, 60%, 50%, 40%, 30%, 20%, 10%, 5%, or 1% (including every value there between) of liquid in a ring is able to pass between two more components (e.g., between the ring wall and an inserted removable panel) are also contemplated.

Openable ring 110 may have at least one slot opening 140 that transverses at least a portion of exterior surface 122 and interior surface 124 of wall 120. In one particular embodiment, the length of slot opening 140 may be less than the length of groove 130. Multiple slot openings 140 may transverse wall 120. In such a case, multiple optional removable panels 170 may be utilized. The number of slot openings 140 may coincide with the number of grooves 130, though such correlation is not required. Slot opening 140 may be arranged to provide an optional sealed interface, for example when removable panel 170 is maximally inserted into ring 110. In one embodiment, such optional sealed interface may be, for example, substantially liquid-tight or otherwise capable of reducing the amount of or preventing a liquid from passing through slot opening 140 when openable ring 110 contains a liquid. If multiple slot openings 140 are included with openable ring 110, it may be desirable, for example, to include one or more plugs (not shown) to plug any slot openings 140 not retaining an optional removable panel 170, thereby maintaining such sealed interface. Plugging a slot opening with a plug can reduce or prevent liquid or other consistency ingredients from exiting through a slot opening that does not include a removable panel. Thus, if a ring includes two or more slot openings, and only one panel is inserted, a plug may be used to close the remaining slot openings as desired.

Non-openable ring 210 may have at least one slot opening 240 that transverses at least a portion of exterior surface 222 and interior surface 224 of wall 220. FIG. 14 illustrates an embodiment that includes a single slot opening 240. In one particular embodiment, the length of slot opening 240 may be less than the length of groove 230. Multiple slot openings 240 may transverse wall 220. In such a case, multiple optional removable panels 170 may be utilized. The number of slot openings 240 may coincide with the number of grooves 230, though such correlation is not required. Slot opening 240 may be arranged to provide an optional sealed interface, for example when removable panel 170 is maximally inserted into ring 210. In one embodiment, such optional sealed interface may be, for example, substantially liquid-tight or otherwise capable of reducing the amount of or preventing a liquid from passing through slot opening 240 when non-openable ring 210 contains a liquid. If multiple slot openings 240 are included with non-openable ring 210, it may be desirable, for example, to include one or more plugs (not shown) to plug any slot openings 240 not retaining an optional removable panel 170, thereby maintaining such sealed interface. Plugging a slot opening with a plug can reduce or prevent liquid or other consistency ingredients from exiting through a slot opening that does not include a removable panel. Thus, if a ring includes two or more slot openings, and only one panel is inserted, a plug may be used to close the remaining slot openings as desired.

Optional removable panel 170 may include body portion 172, edge portion 174, and handle portion 176. Removable panel 170 may be, for example, insertable through slot opening 140 or 240. As removable panel 170 is pushed into slot opening 140 or 240, it may travel along a plane into groove 130 or 230, respectively. Such plane of travel may be, in one embodiment, substantially parallel to bottom edge 128. If removable panel 170 is maximally inserted into slot opening 140 or 240, an edge portion 174 of removable panel 170 may come into contact with, rest on, or otherwise enter a portion of groove 130 or 230, respectively. Optional removable panel 170 may be arranged to provide an optional sealed interface between panel 170 and ring 110 or 210. In one embodiment, such optional sealed interface may be, for example, substantially liquid-tight or otherwise capable of reducing the amount of or preventing a liquid from passing between groove 130 or 230 and removable panel 170, for example, when panel 170 is in its maximally inserted position in the openable or non-openable ring, respectively.

FIG. 6 illustrates a side perspective view of an ingredient preparation device, configured in accordance with an embodiment of the present invention. As can be seen, in one embodiment, multiple rings 110 may be arranged in a stacked formation. A top edge 126 of a first ring 110 and/or a bottom edge 128 of a second ring 110 may be configured and/or arranged so as to permit top edge 126 of the first ring 110 to interlock, nest, mate, and/or join with a bottom edge 128 of the second ring 110 during such stacking. A closure element 150 of each openable ring 110 may be arranged so as to align vertically to increase the ease of opening and/or closing the rings 110, though such arrangement is not essential to the proper functioning of each device 100. Similarly, a hinge 160 of each openable ring 110 may be arranged so as to align vertically to increase the ease of opening and/or closing the rings 110, though such arrangement is not essential to the proper functioning of each device 100. One or more optional removable panels 170 may be utilized to separate various ingredients placed in each openable ring 110. In some embodiments, two or more stacked rings are interconnected (e.g., interlocked) with each other with the lower edge of an upper ring interconnecting with the upper edge of a lower ring that is aligned with the upper ring. Such interconnected, stacked, aligned rings can be opened in unison when one of the rings is opened. In some embodiments, opening one ring in a stack of two or more interconnected rings may also open the remaining one or more rings in the stack. It is envisioned that two, three, four, or more rings can be aligned, stacked, and interconnected for use in some embodiments of the invention.

Similarly, in some embodiments, multiple rings 210 may be arranged in a stacked formation. A top edge 226 of a first ring 210 and/or a bottom edge 228 of a second ring 210 may be configured and/or arranged so as to permit top edge 226 of the first ring 210 to interlock, nest, mate, and/or join with the bottom edge 228 of the second ring 210 during such stacking. One or more optional removable panels 170 may be utilized to separate various ingredients placed in each non-openable ring 210. In some embodiments, two stacked rings are interconnect (e.g., interlock) with the lower edge of an upper ring interconnecting with the upper edge of a lower ring that is aligned with the upper ring. It is envisioned that two, three, four, or more rings can be aligned, stacked, and interconnected for use in some embodiments of the invention. In some embodiments, one or more openable rings 110 can be stacked as describes and/or one or more non-openable rings 210 may be stacked. In some embodiments, one or more openable ring 110 and one or more non-openable ring 210 may be stacked together.

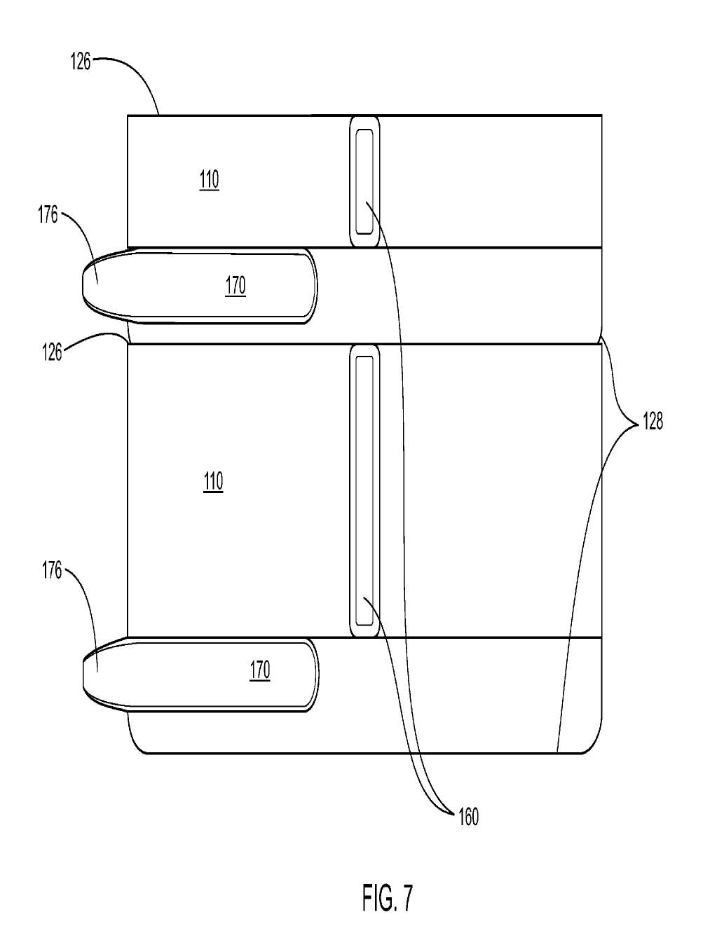

FIG. 7 illustrates a side plan view of a pair of stacked ingredient preparation devices, configured in accordance with an embodiment of the present invention. As can be seen, openable rings 110 need not be of identical or equivalent height. In one embodiment, when stacking openable rings 110, it may be desirable to use rings 110 having continuous vertical walls of varied heights. In one instance, one or more optional removable panels 170 may be utilized in rings 110. Similarly, non-openable rings 210 of equal or unequal height can be stacked together. Openable and non-openable rings of equal and/or unequal heights can be stacked together in certain embodiments of the invention.

FIG. 8 illustrates a side perspective view of an ingredient preparation device assembled with an optional shaped insert, configured in accordance with an embodiment of the present invention. Ingredient preparation device 100 or 200 may include an optional shaped insert 180. Shaped insert 180 may be, in one particular embodiment, a single piece that is insertable into openable ring 110 or non-openable ring 210. In another embodiment, shaped insert 180 may be made of two, three, four, or more separate pieces, such as, but not limited to, a first portion 182 and a second portion 184. Portions 182 and 184 may be symmetrical or may be asymmetrical in accordance with desired shape to be achieved. Shaped insert 180 may be of any shape, including, but not limited to, a square, a heart, a polygon, a triangle, an oval, a star, a tree, an animal, a building, a car, a flower, or a plant, etc. Shaped insert 180 may be sized and/or shaped so as to fit within openable ring 110 or within non-openable ring 210. In some embodiments, the fit of the shaped insert in the ring may be such that the insert is held in place in the closed ring.

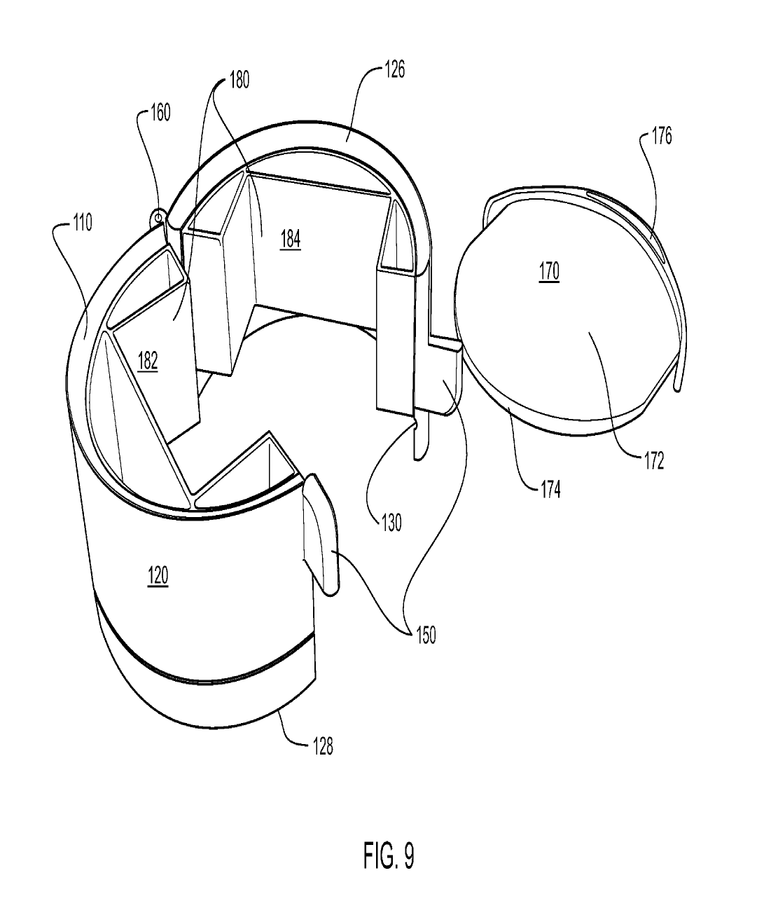

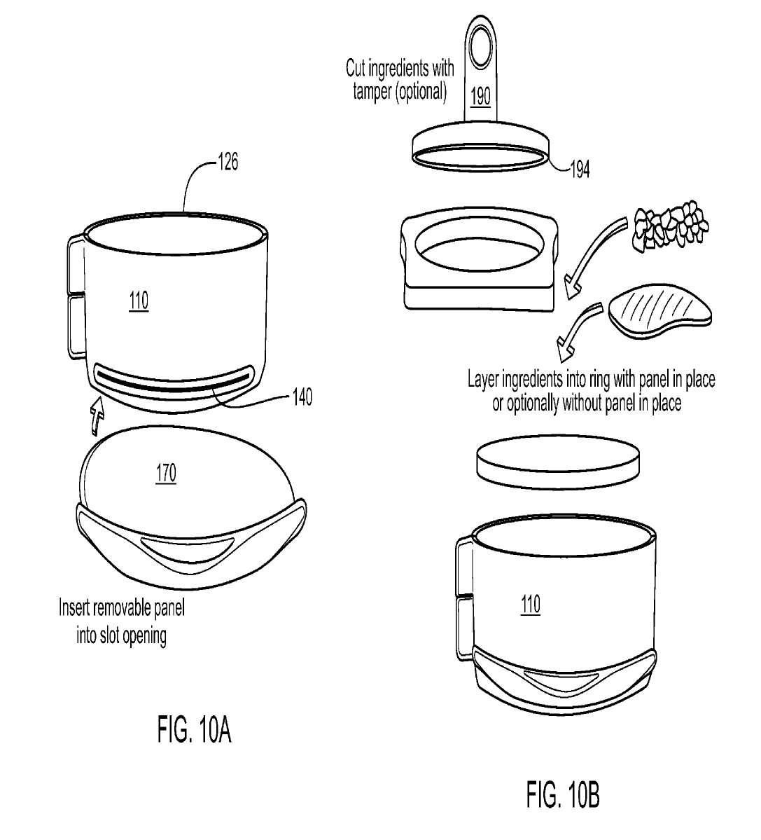

FIG. 9 illustrates an exploded side-perspective view of an ingredient preparation device with an optional shaped insert, configured in accordance with an embodiment of the present invention. As can be seen, groove 130 may be positioned, for example, low along continuous vertical wall 120 so as to permit insertion of optional removable panel 170 beneath optional shaped insert 180. In another embodiment, one or more grooves 130 may be positioned at various heights along wall 120 so as to permit use of multiple panels 170 and multiple shaped inserts 180 in one or more openable rings 110. In one particular embodiment, shaped insert 180 may be split into, for example, first portion 182 and second portion 184 at positions aligned with closure element 150 and/or hinge 160, though this is not essential for the proper functioning of device 100. In some embodiments of the invention an insert may be placed inside and connected to an openable ring of the invention in a manner such that when the ring is opened the insert also opens along a split in the insert. FIG. 9 illustrates an embodiment of the invention in which the insert is connected to the ring such that when the ring is opened, the insert simultaneously opens. It will be understood that inserts can be similarly arranged in a non-openable ring 210 of the invention that has one more grooves positioned in the ring and utilizing one or more removable panels 170. It will be understood that one or more inserts as described herein can be used in an openable or non-openable ring of the invention.

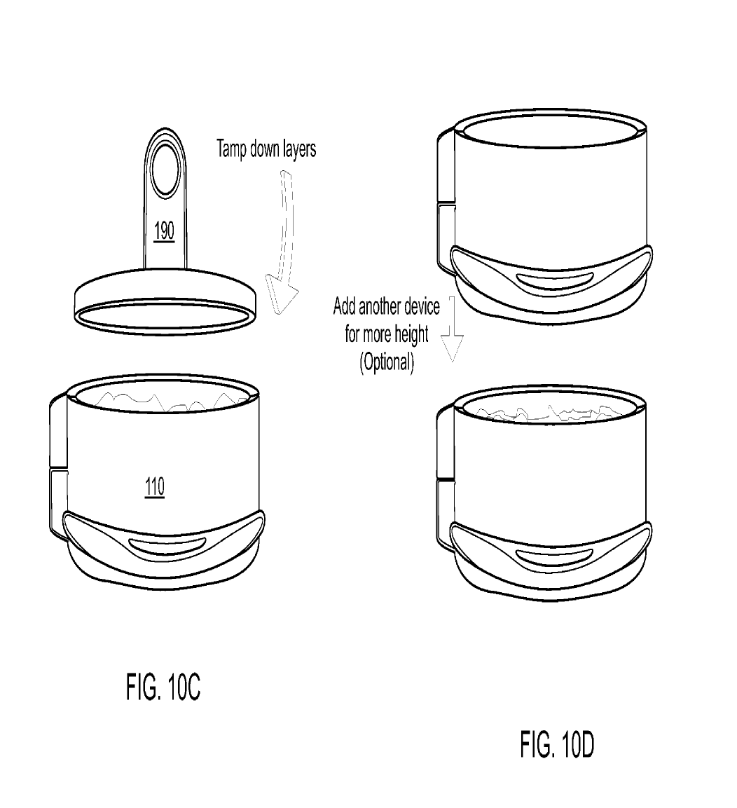

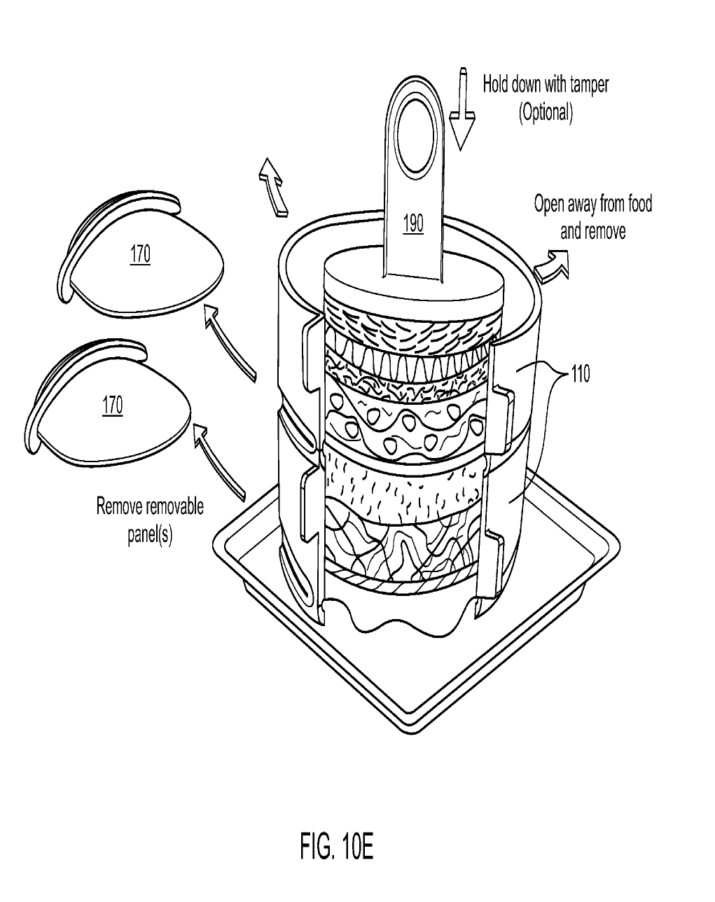

FIG. 10 illustrates a method of preparing ingredients, configured in accordance with an embodiment of the present invention. As can be seen, in FIG. 10A, optional removable panel 170 may be inserted into slot opening 140 of openable ring 110. In FIG. 10B, one or more ingredients may be cut using optional cutting edge 194 of tamper 190. Ingredients may be layered into ring 110 with panel 170 in place or optionally without panel 170. In FIG. 10C, one or more layers of ingredients may be tamped or pressed down tightly within ring 110 by use of tamper 190. In FIG. 10D, a second ring 110 and optional removable panel 170 may be stacked on top of the first ring 110. In FIG. 10E, one or more removable panels 170 may be removed and one or more openable rings 110 may be opened while optionally holding the ingredients in place with tamper 190 to ensure stability. Methods of preparing ingredients using ingredient preparation device 200 may include steps as described in FIG. 10 for device 100, with the omission of a ring-opening step.

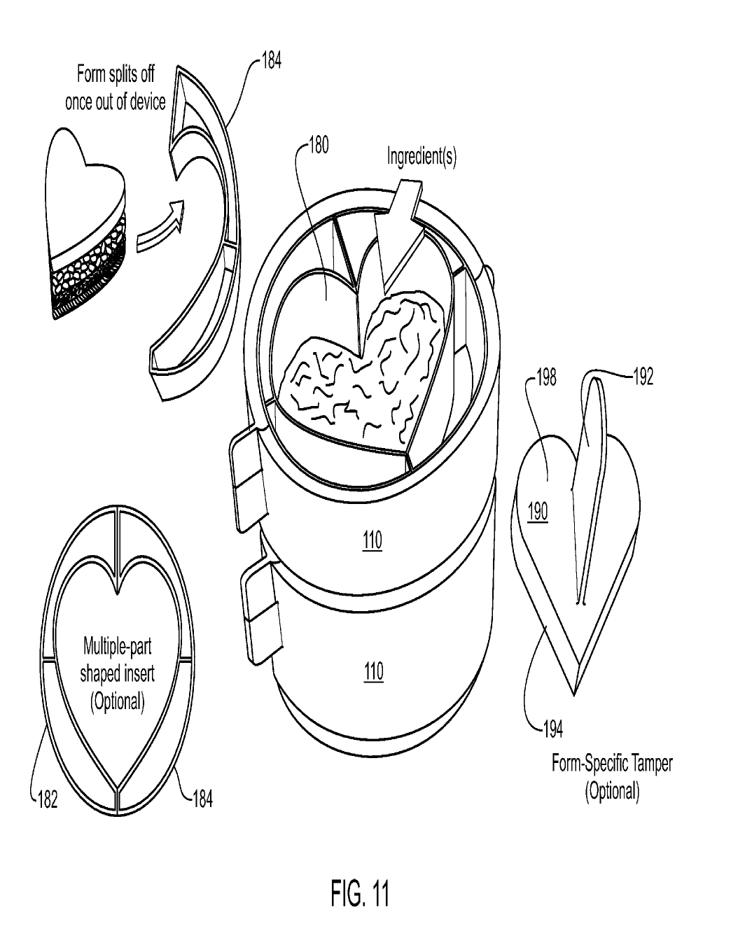

FIG. 11 illustrates an exploded perspective view of an ingredient preparation device with an optional insert, configured in accordance with an embodiment of the present invention. As can be seen, in one embodiment, optional shaped insert 180 may fit within openable ring 110. Shaped insert 180 may include, for example, a first portion 182 and a second portion 184 that may split off away from any ingredients arranged in ring 110. In one particular embodiment, tamper 190 may be of a specific form to match the shape of shaped insert 180. Methods of preparing ingredients using ingredient preparation device 200 may include steps as described in FIG. 11 for device 100.

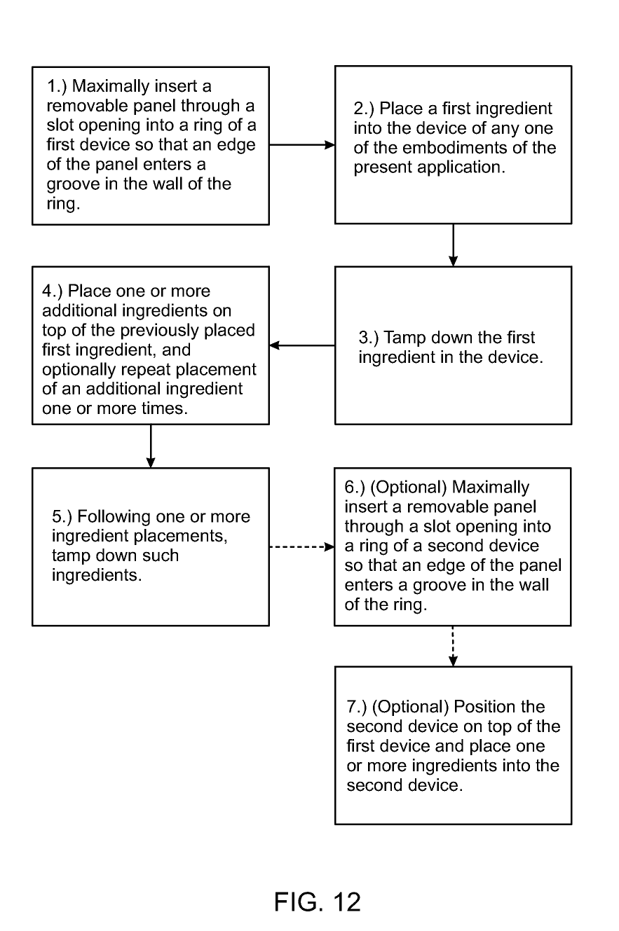

FIG. 12 illustrates a flow diagram illustrating a method of preparing ingredients, configured in accordance with an embodiment of the present invention. The flow diagram is not arranged in an invariable order, and some steps may be optional. As can be seen, in 1, a removable panel may be maximally inserted through a slot opening into an openable or non-openable ring of a first ingredient preparation device so that an edge portion of the panel enters a groove in the wall of the ring. In 2, a first ingredient or multiple ingredients may be placed into the ingredient preparation device of any of the embodiments of the invention described herein. In 3, the first ingredient may be tamped down in the ingredient preparation device. In 4, one or more additional ingredients may be placed on top of the previously placed first ingredient, and placement of additional ingredients may be repeated optionally. In 5, following one or more of the previous ingredient placements, such ingredients may be tamped down. In 6, optionally two or more devices may be used and a removable panel may be maximally inserted through a slot opening into an openable ring or a non-openable ring of a second ingredient preparation device so that an edge portion of the panel enters a groove in the wall of the ring. In 7, the second device may be positioned on top of the first device and one or more ingredients placed therein. It will be understood that one or more additional, optional steps may also be included when using an ingredient preparation device of the invention, non-limiting examples of additional steps include heating, cooling, tamping down, moving to a desired surface, etc.

FIG. 13 illustrates an exploded perspective view of an ingredient preparation device with an optional insert, configured in accordance with an embodiment of the present invention. In this illustrated embodiment, the ring is an openable ring. FIG. 13 illustrates groove 130 and major interior surface 124 of an embodiment of an openable ring.

FIG. 14 illustrates an exploded perspective view of an ingredient preparation device with an optional insert, configured in accordance with an embodiment of the present invention. In this illustrated embodiment, the ring is a non-openable ring. FIG. 14 illustrates groove 230 and major interior surface 224 of an embodiment of a non-openable ring.

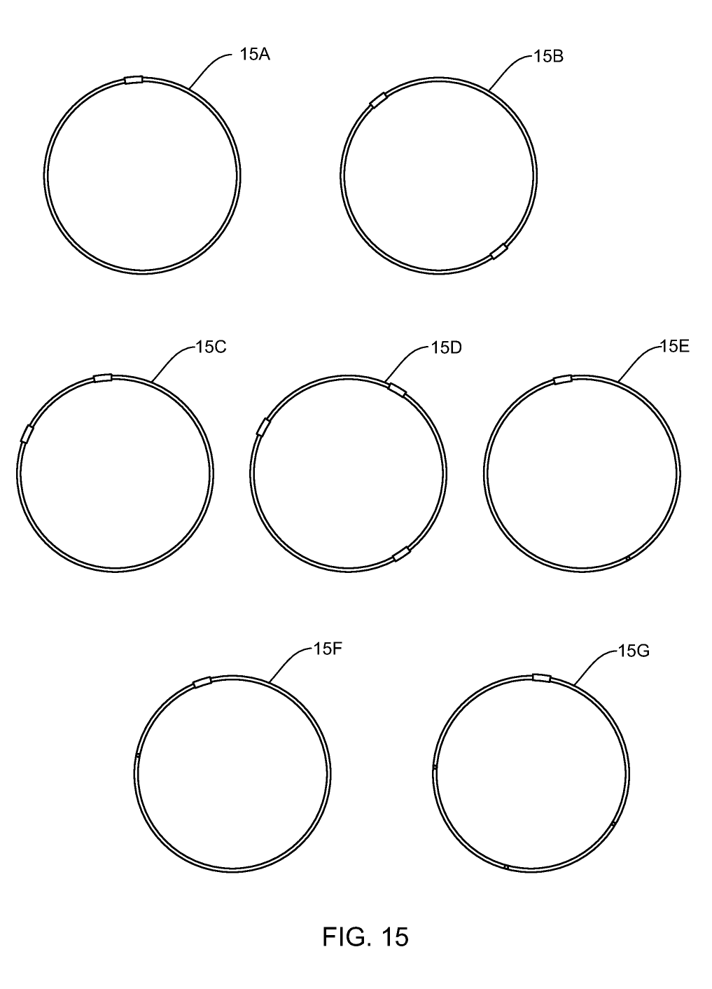

It will be understood that alternative configurations of openable rings of devices of the invention are contemplated. For example, a ring of the invention may have one closure element and no hinges; two, three, four, five, or more closure elements and no hinges; two, three, four, five, or more closure elements and one, two, three, four, five, or more hinges, etc. FIG. 15 provides diagrams of hinge/opening configurations of embodiments of rings of devices configured in accordance with some embodiments of the present invention. The numbers of openings and/or hinges and the relative positions of openings and/or hinges shown in top-view, schematic ring images of FIG. 15 are not intended to be limiting and not all possible configurations are illustrated. FIG. 15A shows a ring that includes a wall having one opening and no hinge. The opening may have a closure element positioned at the opening that can hold the ring in the closed configuration. The ring can be made of a flexible material that permits the ring to be opened when the closure element is not holding the ring in its closed configuration. Thus, the edges of the vertical wall opening in the ring can be separated from each other when the ring is in the open position, compared to their “continuous” position when the ring is in a closed configuration. FIG. 15B shows an example of a ring that includes a wall having two vertical openings and no hinge. The ring of FIG. 15B can separate into two pieces having approximately equal lengths when opened. FIG. 15C shows another example of a ring that includes a wall having two vertical openings and no hinge. The ring of FIG. 15C can be separated into two pieces having unequal lengths when opened. FIG. 15D shows an example of a ring that includes a wall having three vertical openings and no hinge. The ring of FIG. 15D can separate into three pieces if opened at the three openings or can separate into two pieces if opened at two openings, etc. The ring of FIG. 15E shows an example of a ring that includes a wall having one vertical opening and one hinge that is positioned approximately opposite the vertical wall opening. The ring of FIG. 15E can swing open at the hinge when opened. FIG. 15F shows an example of a ring that includes one vertical wall opening and one hinge, in which the hinge is not positioned opposite the vertical wall opening. FIG. 15G shows an example of a ring that includes one vertical wall opening and three hinges. The walls on each side of any or all of the hinges can swing open when the ring is opened. Numerous additional configurations of openable rings are contemplated and are encompassed by the invention.

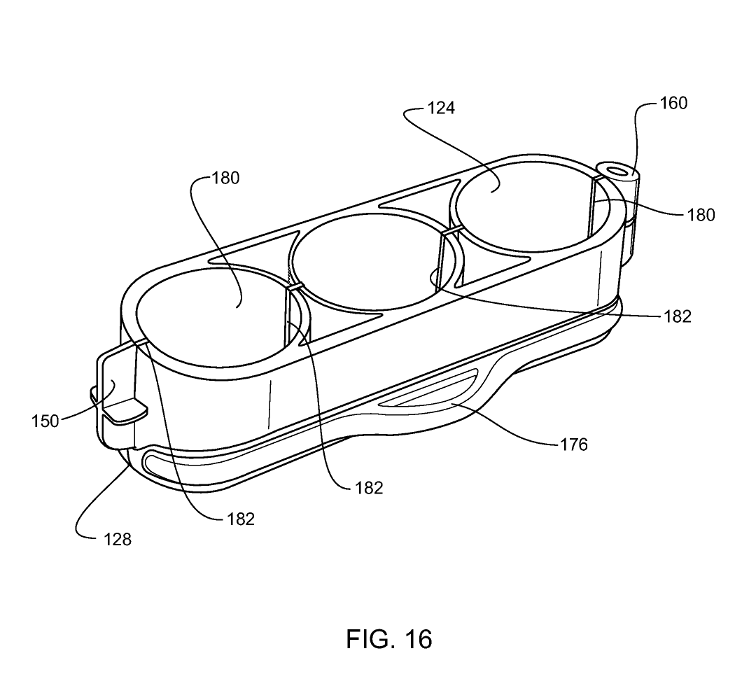

FIGS. 16-19 provide diagrams of non-limiting examples of different configurations of rings configured in accordance with certain embodiments of the present invention. FIG. 16 shows a ring having a closure element 150, a hinge 160, a handle for a removable panel 176 (removable panel is shown in its maximally inserted position), an interior surface 124 of wall 120. The wall of the ring is shown as being made of two materials, one shown 180 (in green) at the wall edges of the vertical wall openings and at the bottom edge of the ring, and the other material is shown making up the remainder of the ring. When opened, such a ring swings at the hinge and each of the circular sections shown splits along the vertical wall opening 182.

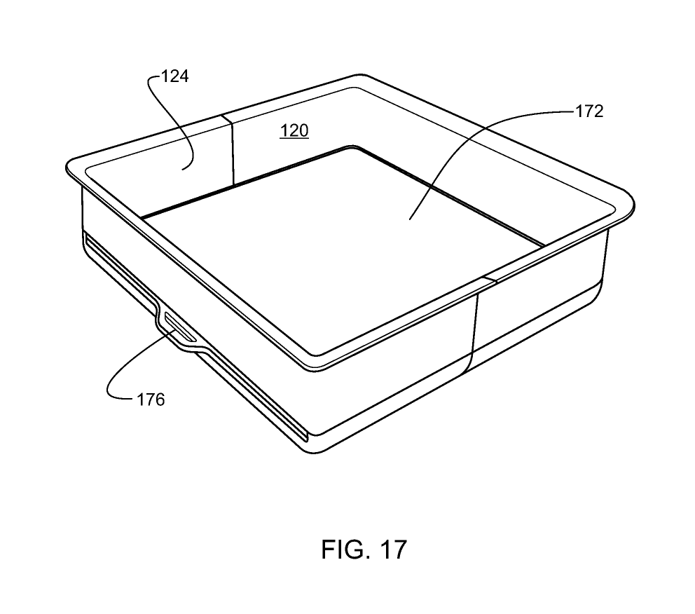

FIG. 17 shows a non-openable ring having, a handle for a removable panel 176 (removable panel is shown in its maximally inserted position), an interior surface 124 of wall 120, configured in accordance with an embodiment of the present invention. The ring as shown has a shape that is substantially square. The wall of the ring as illustrated is shown made of two materials, with different shades indicating the different materials. It is understood that use two or more different materials is not required and that a ring of the invention may, in some embodiments, be constructed of a single material. In the non-limiting embodiment shown in FIG. 17, one material is shown at the bottom edge of the ring, with the second material shown making up the remainder of the ring.

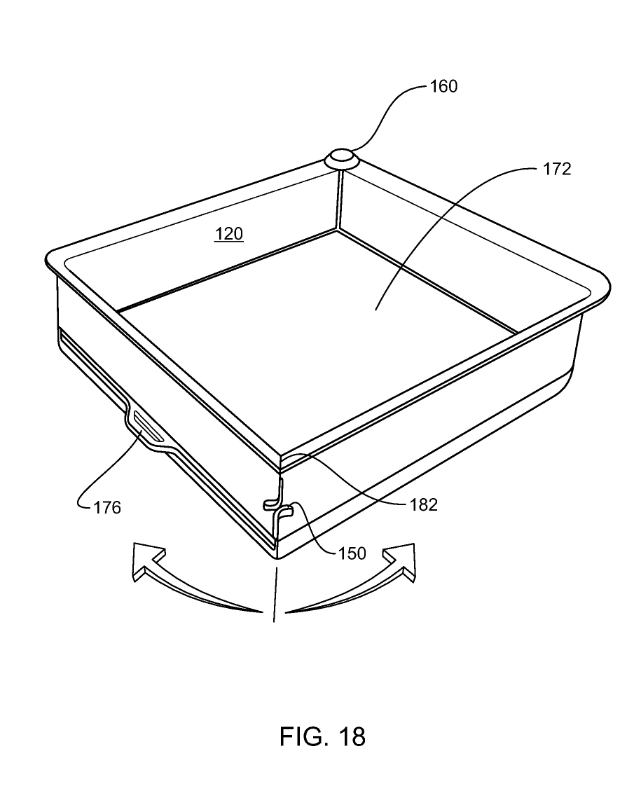

FIG. 18 shows a ring comprising closure element 150, hinge 160, wall opening 182, a handle for removable panel 176 (removable panel is shown in its maximally inserted position), interior surface of wall 120, configured in accordance with an embodiment of the present invention. The wall of the ring is shown as being made of two materials, one material (shown in green) at the wall edges of the vertical wall openings, at the hinge wall edges, and at the bottom edge of the ring. The second material is shown as making up the remainder of the ring. The walls of the ring shown are configured in a substantially square shape.

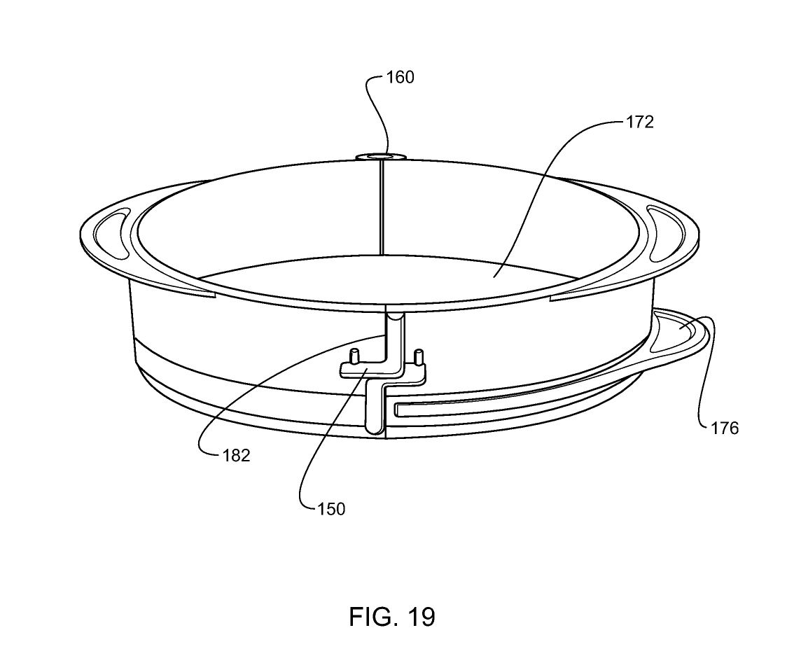

FIG. 19 shows a ring comprising closure element 150, hinge 160, handle for a removable panel 176 (removable panel is shown in its maximally inserted position), and wall opening 182, configured in accordance with an embodiment of the present invention. The wall of the ring is shown as being made of two materials, one material (shown in green) at the wall edges of the vertical wall openings and at the bottom edge of the ring, and the other material is shown making up the remainder of the ring. When opened, such a ring swings at the hinge and opens along the vertical wall opening 182.

As used herein, the term “component” used in reference to a device of the invention can be a removable panel, a ring, a tamper, an insert, a removable divider, a hinge, a closure element, a lid, a cover, etc. In some embodiments, one or more of the components of ingredient preparation device 100 or 200, such as an openable ring 110, non-openable ring 210, closure element 150, hinge 160, optional removable panel 170, optional shaped insert 180, tamper 190, etc. may be constructed of materials capable of use in a wide range of temperatures and environments. Such materials may include, but are not limited to, plastic, nylon, ceramic, metal, wood, silicone, Teflon®, nitrile, glass, etc. One or more of the various components may be constructed of a single material or any combination of materials. Embodiments in which the various components are constructed of varied materials different from one another may be realized. Furthermore, one or more components may be constructed of a single material or any combination of materials thus making a device of the invention suitable for use over a wide range of temperatures and conditions. A component of a device of the invention, (e.g., a removable panel, a ring, a lid, a cover, a tamper, an insert, etc.) may be made of a single material or two or more materials, which can be arranged adjacent to each other and/or in layers on the component. A component of a device of the invention may include features such as one or more handles, loops, holes for hanging, ridges, indents, vents, holes, etc.

In some embodiments, one or more of the components of ingredient preparation device 100 or 200 may be constructed of one or more materials capable of withstanding high temperatures, low temperatures, and/or any temperature there between, including, but not limited to ambient temperature and/or room temperature.

A component (e.g., a removable panel, a ring, a lid, a cover, a tamper, an insert, etc.) of a device of the invention can be of any color, multicolored, or may have no color (e.g. be clear). A component may be translucent, transparent, opaque, or combination thereof. A component may include markings such as indicia of levels, amounts, or volumes and/or may have decorative markings on the surface, etched into, and/or inserted onto or into a material of the component. A component may be smooth or may have a texture, or a combination thereof. An ingredient preparation device of the invention may include components of a single color and/or texture, or may include components of two or more colors and/or textures.

In some embodiments of the invention a wall of a ring of device 100 or 200 may be made of a single material. For example, the wall of ring 110 or 210 may be made entirely of glass, metal, silicone, or other suitable material. In certain embodiments of the invention, a wall of a ring of device 100 or 200 may be made of two, three, four, or more different materials. For example, a portion of a ring 110 or 210 that includes groove 130 or 230 and slot opening 140 or 240 may be made of a material such as silicone and a different portion of the same ring may be made of glass, metal, or another material. A non-limiting example of a component of a device of the invention being made of more than one material is illustrated in FIG. 4, which shows a region of the wall of the ring that is composed of one material (shown as transparent) and a region of the wall of the ring that includes a groove that is composed of a different material (shown as solid). Thus, in some embodiments of the invention, a first portion of a wall, which includes a groove and slot opening, may be made of one material (e.g. silicone) and a second portion of the wall may be made of another material (e.g. glass, plastic or metal). It will be understood that the size and shape of regions made of different materials may vary in different embodiments of the invention.

In some embodiments, all or a portion of a component of a device of the invention may be made of two or more different materials that are layered together. Thus, in some embodiments of the invention a portion of the interior of a wall, including a groove and slot opening, may be made of silicone that is layered over another material such as glass, metal, etc. and the remaining portion of the wall may be made glass, metal, etc., without a layer of silicone. As a non-limiting example, a wall of a ring of a device may be made of a first material such as glass or metal that extends the full height of the wall, but that includes a layer of a second material (e.g. silicone, etc.) on a portion of the interior of the wall that includes the groove and slot opening.

In some embodiment of the invention, a portion of a wall that includes a groove and slot opening and/or a portion or all of a removable panel may be made of a material that provides a sealed interface between the removable panel and the wall of the device when the panel is maximally inserted. A sealed interface may be substantially liquid-tight. A portion of a wall that includes a groove and slot opening and/or at least a portion of the removable panel can be made of materials that are known in the art, and may include but are not limited to, rubber, silicone, nitrile, Teflon®, etc., which may be food-grade materials. Suitable materials to provide a sealed interface between a maximally inserted removable panel and the ring into which the panel is inserted, are materials that reduce or prevent a liquid from passing between the edge of the panel and the ring when the panel is maximally inserted. Thus, a maximally inserted removable panel in contact with a groove that may be made of a material such as silicone, nitrile, plastic, rubber, glass, metal, etc., can provide a substantially liquid-tight, sealed interface between the removable panel and the ring. A material such as rubber, silicone, etc. can be positioned throughout a portion of or the full extent of the groove that traverses a wall's interior circumference. An opening through the material can be the slot through which a removable panel can be inserted into a ring of a device of the invention. It will be understood that in some embodiments, a portion of a wall that includes a groove and slot opening and a portion or all of a removable panel may be made of the same or different materials. For example, the portion of the wall that includes the groove and slot opening may be made of silicone, and the removable panel may be made of glass, metal, plastic etc. and may or may not include silicone in one or more regions of the panel, e.g., on an edge of the removable panel. Components such as the portion of a wall that includes a groove and slot opening and/or a portion or all of a removable panel can be made of different materials selected to permit formation of a substantially liquid-tight, sealed interface when the removable panel is maximally inserted through the slot opening into a device.

In some embodiments, one or more of the components of ingredient preparation device 100 or 200 may be constructed of one or more materials capable of withstanding high temperatures. High temperatures may include, but are not limited to, at least 100° F., 150° F., 200° F., 250° F., 300° F., 350° F., 400° F., 450° F., 500° F., or higher, including all temperatures below and there between. Such construction may permit a user to utilize components of the device 100 or 200 in, for example, baking, broiling, frying, dehydrating, or any other application of high temperatures as would occur to one of ordinary skill in the art. One skilled in the art will be able to recognize and utilize appropriate material or materials for high-temperature applications.

In some embodiments, one or more of the components of ingredient preparation device 100 or 200 may be constructed of one or more materials capable of withstanding low temperatures. Low temperatures may include, but are not limited to, temperatures down to 60° F., 50° F., 40° F., 30° F., 20° F., 10° F., 5° F., 0° F., −5° F., −10° F., −25° F., −35° F., −45° F., −50° F., or lower, including all temperatures above and there between. Such construction may permit a user to utilize components of the device 100 or 200 for example, gelling, standard freezing, rapid freezing (such as by liquid nitrogen), or any other application of low temperatures as would occur to one of ordinary skill in the art. One skilled in the art will be able to recognize and utilize appropriate material or materials for low-temperature applications.

In some embodiments, one or more components of device 100 or 200 may be constructed of one or more materials that may be cleaned safely within a dishwasher. Components of device 100 or 200 may be constructed of a material that has a non-stick surface. One, two, three, or more components of device 100 or 200 may be constructed of one or more non-toxic, food-safe materials. In some embodiments of the invention, all components of device 100 or 200 are constructed of one or more non-toxic, food-safe materials.

Components of ingredient preparation device 100 or 200 may be used for foods and other edible items. In some embodiments, components of device 100 or 200 may be used for non-edible items and ingredients as would occur to one of ordinary skill in the art.

In some aspects of the invention, multiple stacks of layers can be prepared at one time using a device of the invention configured as a multiple-stacking device so as to include an openable and/or non-openable ring that includes two or more shaped inserts. Thus, in some embodiments two or more (e.g., two, three, four, five, six, or more) shaped inserts can be fitted into a ring. The two or more shaped inserts can be similar to each other in shape and/or size or can differ from each other in size and/or shape. For example, a round insert may be included in a ring with a square insert. Additionally, in some embodiments one insert can be fitted inside a second insert and both can be placed in a ring of the invention. Inserts of the invention can be used to alter a pattern, color, or organization of ingredients within a ring of a preparation device.

One example of a use of inserts in methods and devices of the invention, though not intended to be limiting, is a ring into which two or more shaped inserts are be placed. The inserts can be of the same shape or may have different shapes. The same or different ingredients, and/or amounts of ingredients can be placed in the shaped inserts.

Another example of a use of inserts in methods and devices of the invention, though not intended to be limiting, is a ring into which one insert is placed, and the insert includes two or more openings into which ingredients can be placed. Thus, in some embodiments, a ring may include insert has two, three, four, five, six, or more openings into which one or more ingredients can be placed. An insert that has two or more openings can be used to prepare two or more ingredient stacks using a single insert.

In some embodiments, inserts of the invention can be used with openable and/or non-openable rings to prepare of multiple stacks of ingredients. Ingredients can be added to two or more inserts to prepare the two or more ingredient stacks at the same time, using the same ring or two or more connected (e.g. stacked) rings. Ingredients can also be added to a ring inside and/or outside of an insert that is in the ring. In some embodiments, the type of ingredients placed inside an insert can differ from the type of ingredients placed outside an insert that is positioned in a ring. An insert can also be used to prepare multiple stacks using a ring that contains one or more inserts. In some embodiments, a multiple stacking ring of the invention may be a ring into which two, three, four, five, six, or more individual inserts are placed. In some embodiments, an insert can be place within another insert and both can be placed in a ring. Two or more stacks prepared in such a multiple-stacking device of the invention may include identical layers and ingredients and organization or may differ from each other due to inclusion of different layers and/or ingredients and/or organization. In some embodiments, an insert may have a substantially liquid-tight interface with a panel and/or a ring, though such an interface is not required in all embodiments of the invention.

Device 100 or 200 (with or without the optional tamper) can be used to prepare a variety of ingredients and foods. The shape of a ring 110 or 210 of device 100 or 200, respectively, can be a simple or complex shape and ring 110 or 210 may include a single opening for placement of ingredients, or may include two, three, four, five, six, seven, eight, nine, ten, or more openings for placement of ingredients. For example, in some embodiments of the invention, ring 110 or 210 may provide a single ingredient-placement opening that is useful in methods including, but not limited to, preparing single or multi-serving foods. Thus, rings and devices of the invention are envisioned in a wide range of sizes and configurations for use in methods of preparing food ingredients in amounts suitable for serving sizes that range from less than a single serving up to 1, 2, 3, 4, 5, 6, 7, 8, 9, 10, 15, 20, 25, 50, 100, or more servings, including all amounts in between these values. Rings and devices of the invention can be of any suitable dimension as needed for an intended use. Thus, in some embodiments, a ring of the invention may be up to 0.5 1, 2, 3, 4, 5, 6, 7, 8, 9, 10, 12, 14, 16, 18, 20, 25, 30, or more inches in height including all distances in between these values. In some embodiments of the invention a ring of the invention may be up to 0.5, 1, 2, 3, 4, 5, 6, 7, 8, 9, 10, 12, 14, 16, 18, 20, 25, 30, 40, 50, or more inches in diameter including all distances in between these values.

Ingredient preparation devices of the invention can be used in methods of preparing ingredients such as food ingredients, to prepare compositions such as meat and/or vegetable stacks, single serving cake, bread loaf, pizza, cupcakes, etc. In certain embodiments, one or more ingredients can be placed in a device of the invention configured to assemble and prepare (e.g., cook, or chill, etc.) one food composition that is a suitable size either for a single serving or that can be removed from the ring as a single unit, and then divided into multiple portions after preparation. Thus, in certain embodiments of the invention, a ring 110 or 210 may comprise a single ingredient-placement opening and may be used in methods of preparing a single food such as a cake, bread loaf, pizza, ingredient stack, etc. In some embodiments of the invention, one or more ingredients can be placed in a device of the invention configured to prepare two or more food compositions that are assembled and prepared (e.g. cooked and/or chilled) in different sections and/or inserts in a single ring. Thus, in certain embodiments of the invention, a ring 110 or 210 may comprise multiple ingredient-placement openings or may have inserts that divide a single ingredient placement opening into multiple ingredient placement openings, and that may be used in methods of preparing 1, 2, 3, 4, 5, 6, 7, 8, 9, 10, 15, 20, 25, 50, 100, or more individual servings of foods such as, but not limited to, cupcakes, tarts, biscuits, multiple ingredient stacks, etc.

### EXAMPLES

### Example 1

As illustrated in FIG. 13, an arrangement of ingredients was prepared utilizing the invention of the present application. An openable ring 110 was secured in a closed position via closure element 150. Removable panel 170 was inserted maximally through slot opening 140 until edge portion 174 of panel 170 entered groove 130 in the continuous vertical wall 120 of ring 110. A first ingredient was disposed in ring 110, accumulating on body portion 172 of removable panel 170 until a desired height/level was achieved. Tamper 190 was used to tamp down the first ingredient in ring 110. A second ingredient was disposed subsequently on top of the first ingredient within ring 110. Again, tamper 190 was used to tamp down the second ingredient in ring 110. This process was repeated for two more iterations, resulting in a total of 4 layers of ingredients within ring 110. The entirety of ingredient preparation device 100 was positioned on a plating surface, and removable panel(s) 170 was removed completely from slot opening 140 while maintaining ring 110 in the closed position. Closure element 150 subsequently was disengaged, and openable ring 110 was opened in a direction away from the ingredients and completely removed.

A similar arranged of ingredients is also prepared using a non-openable ring 210 of a device of the invention. The same steps are followed except the stack of layered ingredients is prepared in and removed from the ring without the ring being closed or opened.

### Example 2

An arrangement of cooked and uncooked ingredients is prepared utilizing the invention of the present application. An openable or non-openable ring is used. If an openable ring, the openable ring 110 is secured in a closed position via closure element 150. A removable panel is inserted maximally through slot opening in the openable or non-openable ring until edge portion 174 of panel 170 enters groove 130 in the continuous vertical wall 120 of ring 110 or 174 of panel 170 enters groove 230 in the continuous vertical wall 220 of ring 210. A layer of uncooked cake batter is disposed in each of two openable 110 or non-openable rings 210, accumulating on body portion 172 of removable panel 170 of each ring until a desired height/level is achieved. The rings, panels, and batter are heated to a suitable temperature using an oven until the cake batter is cooked. When cooled, a second ingredient, frosting, is disposed on top of the cooked cake within one of the rings. With each cake remaining in each ring, the ring not containing the frosting is placed on top of the ring with the cake and frosting layers and the removable panel is removed from the top ring. The cake layer from the top ring is placed onto the frosting layer in the lower ring. Optionally, a tamper 190 is used to tamp down the cake from the second ring onto the frosting layer in the first ring. The rings with the removable panel in place in the lower ring are positioned on a plating surface, and the removable panel 170 is removed completely from slot opening in the lower ring. The rings are removed from the cake and frosting layers. In an openable ring 110, the ring is opened by disengaging closure element 150, and opening the ring in a direction away from the ingredients and completely removing the ring 110.

### Example 3

A pizza is prepared, cooked, and de-panned, utilizing the invention of the present application. An openable or non-openable ring is used. If an openable ring, the openable ring 110 is secured in a closed position via closure element 150. A removable panel is inserted maximally through slot opening in the openable or non-openable ring until edge portion 174 of panel 170 enters groove 130 in the continuous vertical wall 120 of ring 110 or 174 of panel 170 enters groove 230 in the continuous vertical wall 220 of ring 210. A layer of uncooked pizza dough is disposed in openable ring 110 or non-openable ring 210, accumulating on body portion 172 of removable panel 170 of the ring until a desired height/level is achieved. The ring, panel, and pizza dough are heated to a suitable temperature using an oven until the pizza dough is sufficiently baked. Additional ingredients such as sauce, vegetables, meats, cheese, etc. are then layered on top of the cooked pizza dough. Optionally, a tamper 190 is used to tamp down the ingredient layers onto the cooked pizza dough. When the ingredients are positioned on the cooked dough in the ring, the ring is placed in the oven and heated to sufficiently heat/cook the added ingredients. The ring is removed from the oven and with the removable panel in place, the ring is positioned on a plating surface and the removable panel 170 is removed completely from slot opening 140 in ring 110 or slot opening 240 in ring 210. The ring is removed from the pizza. When using an openable ring 110, the ring is opened by disengaging closure element 150, and opening the ring in a direction away from the ingredients and completely removing the ring 110. When using a non-openable ring 210, the pizza exits the ring at the wall's bottom edge through the opening previously covered by the removable panel.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications, and publications that are cited or referred to in this application are incorporated in their entirety herein by reference.

What is claimed is:

1. An ingredient preparation device comprising a ring that when closed comprises a continuous vertical wall having a top edge and a bottom edge, a major interior surface, and an exterior surface, the wall comprising a slot opening that transverses a portion of the wall; the device further comprising a removable panel including a first panel portion that is insertable into the ring through the slot opening.

2. The ingredient preparation device of claim 1, wherein the ring further comprises a groove traversing at least a portion of the wall's interior circumference, and whereby an edge of the removable panel is positioned in the groove when the removable panel is maximally inserted into the ring.

3-4. (canceled)

5. The ingredient preparation device of claim 1, wherein the ring is an openable ring.

6. The ingredient preparation device of claim 1, wherein the removable panel comprises a handle portion that extends outside the ring from the slot opening when the removable panel is maximally inserted into the ring.

7-10. (canceled)

11. The ingredient preparation device of claim 2, wherein the groove is aligned with at least one wall edge.

12-20. (canceled)

21. The ingredient preparation device of claim 1, wherein the maximally inserted panel has a sealed interface with the ring.

22. (canceled)

23. The ingredient preparation device of claim 21, wherein the sealed interface is a substantially liquid-tight interface.

24-25. (canceled)

26. The ingredient preparation device of claim 1, wherein the ring comprises one or more hinges.

27. (canceled)

28. The ingredient preparation device of claim 5, wherein the ring comprises a closure element.

29-30. (canceled)

31. The ingredient preparation device of claim 1, wherein the shape of the ring is circular.

32. The ingredient preparation device of claim 1, further comprising one or more shaped inserts that are configured to be fitted within the ring.

33-34. (canceled)

35. The ingredient preparation device of claim 1, wherein the device additionally comprises a tamper comprising a body dimensioned to fit within the ring and a handle.

36. The ingredient preparation device of claim 35, wherein an edge of the body of the tamper comprises a cutting edge.

37. The ingredient preparation device of claim 1, wherein the device is made of a non-toxic, food-safe material.

38. (canceled)

39. The ingredient preparation device of claim 1, wherein the device is temperature resistant up to and including a temperature of at least 100° F., 150° F., 200° F., 250° F., 300° F., 350° F., 400° F., 450° F., or 500° F., including all temperatures in between these temperatures.

40. The ingredient preparation device of claim 1, wherein the device is temperature resistant down to and including a temperature of 60° F., 50° F., 40° F., 30° F., 20° F., 10° F., 5° F., 0° F., −5° F., −10° F., −25° F., −35° F., −45° F., or −50° F., including all temperatures in between these temperatures.

41. The ingredient preparation device of claim 1, wherein the device comprises a non-stick surface.

42. (canceled)

43. The ingredient preparation device of claim 1, wherein a wall edge of the ring is configured to interconnect with a wall edge of a ring of a second ingredient preparation device.

44-47. (canceled)

48. The ingredient preparation device of claim 1, wherein the device further comprises one or more lids or covers.

49. A method of ingredient preparation, the method comprising placing a first ingredient into a ring of a device comprising a ring that when closed comprises a continuous vertical wall having a top edge and a bottom edge, a major interior surface, and an exterior surface, the wall comprising a slot opening that transverses a portion of the wall; the device further comprising a removable panel including a first panel portion that is insertable into the ring through the slot opening.

50-67. (canceled)
